(19) United States
(12) Patent Application Publication
(10) Pub. No.: US 2022/0403194 A1
(43) Pub. Date: Dec. 22, 2022

(54) INK JET RECORDING INK AND IMAGE RECORDING METHOD

(71) Applicant: FUJIFILM Corporation, Tokyo (JP)

(72) Inventors: Hiromichi NUMAZAWA, Kanagawa (JP); Daisuke SASAKI, Kanagawa (JP); Yusuke SAKAI, Kanagawa (JP)

(73) Assignee: FUJIFILM Corporation, Tokyo (JP)

(21) Appl. No.: 17/889,386

(22) Filed: Aug. 16, 2022

Related U.S. Application Data
(63) Continuation of application No. PCT/JP2021/009635, filed on Mar. 10, 2021.

(30) Foreign Application Priority Data
Mar. 30, 2020 (JP) 2020-061102

(51) Int. Cl. C09D 11/328; C09D 11/38; C09D 11/101; C09D 11/037; C09D 11/107; B41M 7/00

(52) U.S. Cl. CPC C09D 11/328; C09D 11/38; C09D 11/101; C09D 11/037; C09D 11/107; B41M 7/0081

(57) ABSTRACT

Provided are an ink jet recording ink containing a squarylium dye represented by Formula 1, polymerizable compounds, a dispersant, and a synergist having at least one group selected from the group consisting of a carboxy group and a sulfo group and at least one ring selected from the group consisting of an aromatic ring and a heteroaromatic ring, and an image recording method:

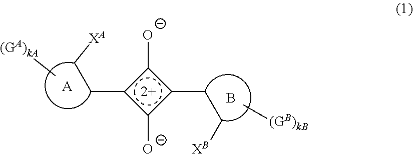

in Formula 1, a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, and kB represents an integer of 0 to nB. nA represents the maximum number of G^{A}s capable of being bonded to the ring A, and nB represents the maximum number of G^{B}s capable of being bonded to the ring B.

### CROSS-REFERENCE TO RELATED APPLICATION

This application is a Continuation of International Application No. PCT/JP2021/009635, filed Mar. 10, 2021, which claims priority to Japanese Patent Application No. 2020-061102 filed Mar. 30, 2020. Each of the above applications is hereby expressly incorporated by reference, in its entirety, into the present application.

### BACKGROUND OF THE INVENTION

### 1. Field of the Invention

The present disclosure relates to an ink jet recording ink and an image recording method.

### 2. Description of the Related Art

Having invisibility, a near-infrared absorbing dye that absorbs infrared rays but substantially does not absorb visible light is expected to be applied in the field of ink.

For example, JP2019-001983A describes an ink jet ink containing a squarylium dye, a dispersant, an organic solvent, and water.

Furthermore, a method is known in which a polymerizable compound is incorporated into an ink and cured with active energy rays to record an image.

For example, JP2011-84727A describes an ink composition containing an isoindoline-based pigment, a pigment dispersing agent, a radically polymerizable compound, and a polymerization initiator.

### SUMMARY OF THE INVENTION

However, in a case where the squarylium dye was dispersed with a dispersant as in JP2019-001983A, the dispersibility was insufficient. In JP2011-84727A, a colored dye is used. However, in this document, the dispersibility in a case where a near-infrared absorbing dye is used is not investigated.

The present disclosure has been made in view of such circumstances, and an object to be achieved by embodiments of the present invention is to provide an ink jet recording ink excellent in dispersibility and temporal stability and an image recording method.

The present disclosure includes the following aspects.

<1> An ink jet recording ink containing a squarylium dye represented by Formula 1, polymerizable compounds, a dispersant, and a synergist having at least one group selected from the group consisting of a carboxy group and a sulfo group and at least one ring selected from the group consisting of an aromatic ring and a heteroaromatic ring.

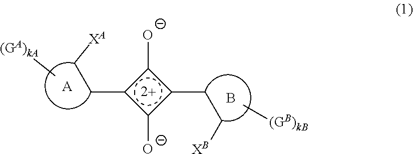

In Formula 1, a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, and kB represents an integer of 0 to nB. nA represents the maximum number of G^{A}s capable of being bonded to the ring A, and nB represents the maximum number of GBs capable of being bonded to the ring B. X^{A} and G^{A} or X^{B} and G^{B} may be bonded to each other to form a ring, and in a case where there is a plurality of G^{A}s and a plurality of GBs, the plurality of G^{A}s bonded to the ring A may be bonded to each other to form a ring structure and the plurality of GBs bonded to the ring B may be bonded to each other to form a ring structure.

<2> The ink jet recording ink described in <1>, in which a base number of the dispersant is 15 mgKOH/g or more.

<3> The ink jet recording ink described in <1> or <2>, in which a ratio of a content of the dispersant to a content of the squarylium dye is 0.5 to 5 based on mass.

<4> The ink jet recording ink described in any one of <1> to <3>, in which at least one of the polymerizable compounds is a polymerizable compound having a solubility parameter of 18 MPa^{1/2} or more, and a content of the polymerizable compound having a solubility parameter of 18 MPa^{1/2} or more is 10% by mass to 40% by mass with respect to a total mass of the ink jet recording ink.

<5> The ink jet recording ink described in any one of <1> to <4>, further containing a polymerization inhibitor, in which a content of the polymerization inhibitor is 1% by mass or more with respect to a total mass of the ink jet recording ink.

<6> The ink jet recording ink described in <5>, in which the polymerization inhibitor is at least one compound selected from the group consisting of a nitrosamine compound, a hindered amine compound, a hydroquinone compound, and a nitroxyl radical.

<7> The ink jet recording ink described in any one of <1> to <6>, further containing a polymerization initiator, in which a content of the polymerization initiator is 10% by mass or more with respect to a total mass of the ink jet recording ink.

<8> The ink jet recording ink described in <7>, in which the polymerization initiator is at least one compound selected from the group consisting of an acylphosphine oxid compound and a thioxanthone compound.

<9> The ink jet recording ink described in any one of <1> to <8>, in which a content of the synergist is 0.005% by mass to 0.1% by mass with respect to a total mass of the ink jet recording ink.

<10> The ink jet recording ink described in any one of <1> to <9>, in which a content of the synergist is 0.12% by mass to 15% by mass with respect to a total mass of the squarylium dye.

<11> An image recording method including a step of applying the ink jet recording ink described in any one of <1> to <10> to a substrate by an ink jet recording method to record an ink image, and a step of irradiating the ink image with active energy rays.

According to the present disclosure, there are provided an ink jet recording ink excellent in dispersibility and temporal stability and an image recording method.

### DESCRIPTION OF THE PREFERRED EMBODIMENTS

Hereinafter, the ink jet recording ink and the image recording method of the present disclosure will be specifically described.

In the present specification, a range of numerical values described using “to” means a range including numerical values described before and after “to” as a minimum value and a maximum value, respectively.

Regarding the ranges of numerical values described stepwise in the present specification, the upper limit or the lower limit described in a certain range of numerical values may be replaced with the upper limit or the lower limit of another range of numerical values described stepwise. In addition, in the ranges of numerical values described in the present specification, the upper limit or the lower limit described in a certain numerical range may be replaced with the value shown in Examples.

In the present specification, in a case where there is a plurality of substances in a composition that corresponds to each component of the composition, unless otherwise specified, the amount of each component of the composition means the total amount of the plurality of substances present in the composition.

In the present specification, a combination of two or more preferred embodiments is a more preferred embodiment.

In the present specification, the term “step” includes not only an independent step but also a step which is not clearly distinguished from another step as long as the intended purpose of the step is achieved.

In the present specification, “(meth)acrylate” has a concept that includes both the acrylate and methacrylate. “(Meth)acryl” is a concept that includes both the acryl and methacryl.

[Ink Jet Recording Ink]

The ink jet recording ink of the present disclosure (hereinafter, simply called “ink”) contains a squarylium dye represented by Formula 1, polymerizable compounds, a dispersant, a synergist having at least one group selected from the group consisting of a carboxy group and a sulfo group and at least one ring selected from the group consisting of an aromatic ring and a heteroaromatic ring.

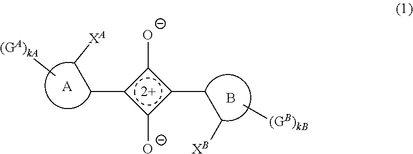

In Formula 1, a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, and kB represents an integer of 0 to nB. nA represents the maximum number of G^{A}s capable of being bonded to the ring A, and nB represents the maximum number of GBs capable of being bonded to the ring B. X^{A} and G^{A} or X^{B} and G^{B} may be bonded to each other to form a ring, and in a case where there is a plurality of G^{A}s and a plurality of G^{B}s, the plurality of G^{A}s bonded to the ring A may be bonded to each other to form a ring structure and the plurality of G^{B}s bonded to the ring B may be bonded to each other to form a ring structure.

In the related art, a recording method has been investigated which is a method of recording an image having invisibility by using an ink containing a near-infrared absorbing dye that has no absorption or low absorption in the visible region. As the near-infrared absorbing dye, a cyanine dye, a phthalocyanine dye, an anthraquinone dye, a diinmonium dye, and a squarylium dye are known. Among these, a squarylium dye is drawing attention because it has high invisibility and light resistance.

As an ink containing a squarylium dye, for example, JP2019-001983A describes an ink jet ink containing a squarylium dye, a dispersant, an organic solvent, and water.

Meanwhile, a method is known in which a polymerizable compound is incorporated into an ink and cured with active energy rays to record an image.

For example, JP2011-84727A describes an ink composition containing an isoindoline-based pigment, a pigment dispersing agent, a radically polymerizable compound, and a polymerization initiator.

In a case where a squarylium dye and a polymerizable compound were simply combined to prepare an ink, dispersibility and temporal stability were insufficient. As a result of intensive studies, the inventors of the present invention have found that an ink excellent in dispersibility and temporal stability is obtained in a case where a synergist having at least one group selected from the group consisting of a carboxy group and a sulfo group and at least one ring selected from the group consisting of an aromatic ring and a heteroaromatic ring is incorporated into the ink together with the squarylium dye represented by Formula 1 and polymerizable compounds. The reason why the ink according to the present disclosure is excellent in dispersibility and temporal stability is presumed as follows.

The squarylium dye represented by Formula 1 has an aromatic ring or a heteroaromatic ring. In addition, the synergist has at least one ring selected from the group consisting of an aromatic ring and a heteroaromatic ring. Due to the π-π interaction between the π-conjugated skeleton of the synergist and the π-conjugated skeleton of the squarylium dye, the synergist is adsorbed onto the surface of the squarylium dye. It is considered that because the synergist has at least one group selected from the group consisting of a carboxy group and a sulfo group, the squarylium dye with the synergist adsorbed onto the surface thereof may be stably dispersed as it is in the ink due to the electrostatic repulsive force between carboxy groups or sulfo groups.

Next, each component contained in the ink according to the present disclosure will be described.

(Squarylium Dye)

The ink according to the present disclosure contains at least one squarylium dye represented by Formula 1.

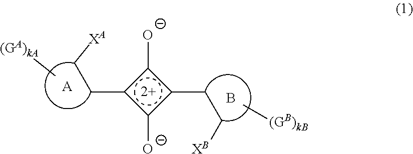

In Formula 1, a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, and kB represents an integer of 0 to nB. nA represents the maximum number of G^{A}s capable of being bonded to the ring A, and nB represents the maximum number of GBs capable of being bonded to the ring B. X^{A} and G^{A} or X^{B} and G^{B} may be bonded to each other to form a ring, and in a case where there is a plurality of G^{A}s and a plurality of GBs, the plurality of G^{A}s bonded to the ring A may be bonded to each other to form a ring structure and the plurality of GBs bonded to the ring B may be bonded to each other to form a ring structure.

[G^{A} and G^{B}]

G^{A} and G^{B} each independently represent a monovalent substituent.

Examples of the monovalent substituent include a halogen atom, a cyano group, a nitro group, an alkyl group, an alkenyl group, an alkynyl group, an aryl group, a heteroaryl group, an aralkyl group, —OR¹⁰, —COR¹¹. —COOR¹², —OCOR¹³, —NR¹⁴R¹⁵, —NHCOR¹⁶, —CONR¹⁷R¹⁸, —NHCONR¹⁹R²⁰, —NHCOOR²¹, —SR²², —SO₂R²³, —SO₂OR²⁴, —NHSO₂R²⁵, and SO₂NR²⁶R²⁷.

R¹⁰ to R²⁷ each independently represent a hydrogen atom, an aliphatic group, an aromatic group, or a heterocyclic group.

In a case where R¹² of —COOR¹² is a hydrogen atom (that is, a carboxy group), the hydrogen atom may be dissociated (that is, a carbonate group) or —COOR¹² may be in a state of salt. In a case where R²⁴ of —SO₂OR²⁴ is a hydrogen atom (that is, a sulfo group), the hydrogen atom may be dissociated (that is, a sulfonate group) or —SO₂OR²⁴ may be in a state of salt.

Examples of the halogen atom include a fluorine atom, a chlorine atom, a bromine atom, and an iodine atom.

The number of carbon atoms in the alkyl group is preferably 1 to 20, more preferably 1 to 15, and even more preferably 1 to 8. The alkyl group may be linear, branched, or cyclic, and is preferably linear or branched.

The number of carbon atoms in the alkenyl group is preferably 2 to 20, more preferably 2 to 12, and particularly preferably 2 to 8. The alkenyl group may be linear, branched, or cyclic, and is preferably linear or branched.

The number of carbon atoms in the alkynyl group is preferably 2 to 40, more preferably 2 to 30, and even more preferably 2 to 25. The alkynyl group may be linear, branched, or cyclic, and is preferably linear or branched.

The number of carbon atoms in the aryl group is preferably 6 to 30, more preferably 6 to 20, and even more preferably 6 to 12.

The alkyl moiety of the aralkyl group is the same as the aforementioned alkyl group. The aryl moiety of the aralkyl group is the same as the aforementioned aryl group. The number of carbon atoms in the aralkyl group is preferably 7 to 40, more preferably 7 to 30, and even more preferably 7 to 25.

The heteroaryl group is preferably a monocyclic ring or a fused ring, more preferably a monocyclic ring or a fused ring composed of 2 to 8 rings fused together, and even more preferably a monocyclic ring or a fused ring composed of 2 to 4 rings fused together. The number of heteroatoms configuring the ring of the heteroaryl group is preferably 1 to 3. The heteroatom configuring the ring of the heteroaryl group is preferably a nitrogen atom, an oxygen atom, or a sulfur atom. The heteroaryl group is preferably a 5-membered ring or a 6-membered ring. The number of carbon atoms configuring the ring of the heteroaryl group is preferably 3 to 30, more preferably 3 to 18, and even more preferably 3 to 12. Examples of the heteroaryl group include a pyridine ring, a piperidine ring, a furan ring, a furfuran ring, a thiophene ring, a pyrrole ring, a quinoline ring, a morpholine ring, an indole ring, an imidazole ring, a pyrazole ring, a carbazole ring, a phenothiazine ring, a phenoxazine ring, an indoline ring, a thiazole ring, a pyrazine ring, a thiadiazine ring, a benzoquinoline ring, and a thiadiazole ring.

The alkyl group, the alkenyl group, the alkynyl group, the aralkyl group, the aryl group, and the heteroaryl group may have a substituent or may be unsubstituted.

Examples of the substituent include the substituents described in paragraph “0030” of JP2018-154672A. Examples of the substituent include an alkyl group, an aryl group, an amino group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, an alkylthio group, an arylthio group, an aromatic heterocyclic thio group, a sulfonyl group, a hydroxy group, a mercapto group, a halogen atom, a cyano group, a sulfo group, and a carboxy group. As the substituent, among these, an alkyl group, an aryl group, an alkoxy group, an aryloxy group, an aromatic heterocyclic oxy group, an acyl group, an alkoxycarbonyl group, an aryloxycarbonyl group, an acyloxy group, an alkylthio group, an arylthio group, an aromatic heterocyclic thio group, a sulfonyl group, a hydroxy group, a mercapto group, a halogen atom, a cyano group, a sulfo group, or a carboxy group is preferable.

“Number of carbon atoms” in a substituent means “total number of carbon atoms” in the substituent. For details of each substituent, the substituents described in paragraphs “0031” to “0035” of JP2018-154672A can be referred to.

[X^{A} and X^{B}]

X^{A} and X^{B} each independently represent a monovalent substituent.

The substituent represented by X^{A} and X^{B} is preferably a group having active hydrogen, more preferably —OH, —SH, —COOH, —SO₃H, —NR^{X1}R^{X2}, —NHCOR^{X1}, —CONR^{X1}R^{X2}, —NHCONR^{X1}R^{X2}, —NHCOOR^{X1}, —NHSO₂R^{X1}, —B(OH)₂, or PO(OH)₂, and even more preferably —OH, —SH, or NR^{X1}R^{X2}

R^{X1} and R^{X2} each independently represent a hydrogen atom or a monovalent substituent. Examples of the substituent include an alkyl group, an alkenyl group, an alkynyl group, an aryl group, and a heteroaryl group. Among these, an alkyl group is preferable as the substituent. The alkyl group is preferably linear or branched. Details of the alkyl group, the alkenyl group, the alkynyl group, the aryl group, and the heteroaryl group are the same as the ranges described above regarding G^{A} and G^{B}.

[Ring A and Ring B]

The ring A and the ring B each independently represent an aromatic ring or a heteroaromatic ring.

The aromatic ring and the heteroaromatic ring may be a monocyclic ring or a fused ring.

Examples of the aromatic ring and the heteroaromatic ring include a benzene ring, a naphthalene ring, a pentalene ring, an indene ring, an azulene ring, a heptalene ring, an indecene ring, a perylene ring, a pentacene ring, an acenaphthalene ring, a phenanthrene ring, an anthracene ring, a naphthacene ring, a chrysene ring, a triphenylene ring, a fluorene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridazine ring, an indolidine ring, an indole ring, a benzofuran ring, a benzothiophene ring, an isobenzofuran ring, a quinolizine ring, a quinoline ring, a phthalazine ring, a naphthyridine ring, a quinoxaline ring, a quinoxazoline ring, an isoquinoline ring, a carbazole ring, a phenanthridine ring, an acridine ring, a phenanthroline ring, a thianthrene ring, a chromene ring, a xanthene ring, a phenoxathiin ring, a phenothiazine ring, and a phenazine ring.

As the ring A and the ring B, among the above, an aromatic ring is preferable, and a benzene ring or a naphthalene ring is more preferable.

The aromatic ring may be unsubstituted or may have a substituent. Examples of the substituent include the substituents described above regarding G^{A} and G^{B}.

X^{A} and G^{A} or X^{B} and G^{B} may be bonded to each other to form a ring. In a case where there is a plurality of G^{A}s and a plurality of G^{B}s, G^{A}s may be bonded to each other to form a ring, and G^{B}s may be bonded to each other to form a ring. The ring is preferably a 5-membered ring or a 6-membered ring. The ring may be a monocyclic ring or a heterocyclic ring.

In a case where X^{A} and G^{A}, X^{B} and G^{B}, G^{A}s, or G^{B}s are bonded to each other to form a ring, these may be directly bonded to each other to form a ring or bonded to each other via a divalent linking group selected from the group consisting of an alkylene group, —CO—, —O—, —NH—, —BR—, and a combination of these to form a ring. It is preferable that X^{A} and G^{A}, X^{B} and G^{B}, G^{A}s, or G^{B}s be bonded to each other via —BR— to form a ring.

R represents a hydrogen atom or a monovalent substituent. Examples of the substituent include the substituents described above regarding G^{A} and G^{B}. As the substituent, an alkyl group or an aryl group is preferable.

[kA and kB]

kA represents an integer of 0 to nA, kB represents an integer of 0 to nB, nA represents the maximum number of G^{A}s capable of being bonded to the ring A, and nB represents the maximum number of GBs capable of being bonded to the ring B.

kA and kB preferably each independently represent 0 to 4, more preferably each independently represent 0 to 2, and particularly preferably each independently represent 0 or 1. It is preferable that a case where kA and kB simultaneously represent 0 (zero) be ruled out.

From the viewpoint of light resistance, the squarylium dye represented by Formula 1 is preferably a compound represented by Formula 2.

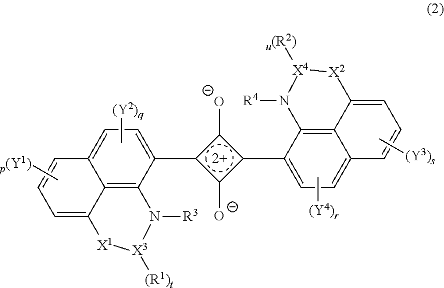

In Formula 2, R¹ and R² each independently represent a monovalent substituent.
R³ and R⁴ each independently represent a hydrogen atom or an alkyl group.
X¹ and X² each independently represent an oxygen atom or —N(R⁵)—.
R⁵ represents a hydrogen atom, an alkyl group, an aryl group, or a heteroaryl group.
X³ and X⁴ each independently represent a carbon atom or a boron atom.
t and u each represent 1 in a case where X³ and X⁴ represent a boron atom, and each represent 2 in a case where X³ and X⁴ represent a carbon atom.
Y¹, Y², Y³, and Y⁴ each independently represent a monovalent substituent. Y¹, Y², Y³ and Y⁴ may be bonded to each other to form a ring.

In a case where there is a plurality of Y¹'s, a plurality of Y²'s, a plurality of Y³'s, and a plurality of Y⁴'s, Y¹'s, Y²'s, Y³'s, and Y⁴'s may be bonded to each other to form a ring.
p and s each independently represent an integer of 0 to 3, and q and r each independently represent an integer of 0 to 2.

[R¹ and R²]

R¹ and R² may be the same as or different from each other. It is preferable that R¹ and R² be the same as each other. In a case where t and u each represent 2, two R¹'s may be the same as or different from each other and two R²'s may be the same as or different from each other. It is preferable that two R¹'s be the same as each other and two R²'s be the same as each other.

Examples of the monovalent substituent represented by R¹ and R² include the same monovalent substituents as G^{A} and G^{B}. As R¹ and R², among the above, an aryl group is preferable. The aryl group may have a monovalent substituent or may be unsubstituted. The number of carbon atoms in the aryl group is preferably 6 to 30, more preferably 6 to 20, and even more preferably 6 to 12. Specifically, R¹ and R² are preferably a phenyl group or a naphthyl group, and more preferably a phenyl group.

[Y¹, Y², Y³, and Y⁴]

Examples of the monovalent substituent represented by Y¹, Y², Y³, and Y⁴ include the same monovalent substituents as G^{A} and G^{B}.

[p, q, r, and s]

p, q, r and s are preferably 0. That is, it is preferable that Formula 2 be devoid of Y¹, Y², Y³, and Y⁴.

[X¹ and X²]

X¹ and X² may be the same as or different from each other. It is preferable that X¹ and X² be the same as each other. It is preferable that X¹ and X² be —N(R⁵)—.

[R⁵]

The alkyl group, the aryl group, and the heteroaryl group represented by R⁵ may be unsubstituted or may have a monovalent substituent. Examples of the monovalent substituent include the same monovalent substituents as G^{A} and G^{B}.

The number of carbon atoms in the alkyl group is preferably 1 to 20, more preferably 1 to 10, even more preferably 1 to 4, and particularly preferably 1 or 2. The alkyl group may be linear or branched.

The aryl group preferably has 6 to 20 carbon atoms, and more preferably has 6 to 12 carbon atoms.

The heteroaryl group may be monocyclic or polycyclic. The number of heteroatoms configuring the ring of the heteroaryl group is preferably 1 to 3. The heteroatom configuring the ring of the heteroaryl group is preferably a nitrogen atom, an oxygen atom, or a sulfur atom. The number of carbon atoms configuring the ring of the heteroaryl group is preferably 3 to 30, more preferably 3 to 18, and even more preferably 3 to 12.

R⁵ is preferably a hydrogen atom, a methyl group, or an ethyl group, more preferably a hydrogen atom or a methyl group, and even more preferably a hydrogen atom.

[X³ and X⁴]

X³ and X⁴ may be the same as or different from each other. It is preferable that X³ and X⁴ be the same as each other. It is preferable that X³ and X⁴ be a boron atom.

[R³ and R⁴]

The number of carbon atoms in the alkyl group represented by R³ and R⁴ is preferably 1 to 4, and more preferably 1 or 2. The alkyl group may be linear or branched. Examples of the alkyl group include a methyl group, an ethyl group, a n-propyl group, an isopropyl group, a n-butyl group, and an isobutyl group. R³ and R⁴ preferably each independently represent a hydrogen atom, a methyl group, or an ethyl group, more preferably each independently represent a hydrogen atom or a methyl group, and even more preferably each independently represent a hydrogen atom.

The molecular weight of the squarylium dye represented by Formula 1 is preferably 100 to 2,000, and more preferably 150 to 1,000.

The squarylium dye represented by Formula 1 is specifically described in JP2011-2080101A, and the compounds described in JP2011-2080101A can be suitably used as the squarylium dye in the present disclosure.

The squarylium dye represented by Formula 1 and the squarylium dye represented by Formula 2 may be tautomers thereof. For the tautomers, for example, what are described in paragraph “0034” of WO2016/136783A can be referred to.

Specific examples (Specific Examples B-1 to B-40) of the squarylium dyes represented by Formula 1 or Formula 2 will be shown below. However, in the present disclosure, the squarylium dyes are not limited to the following compounds. In the formulas, “Me” represents a methyl group, and “Ph” represents a phenyl group.

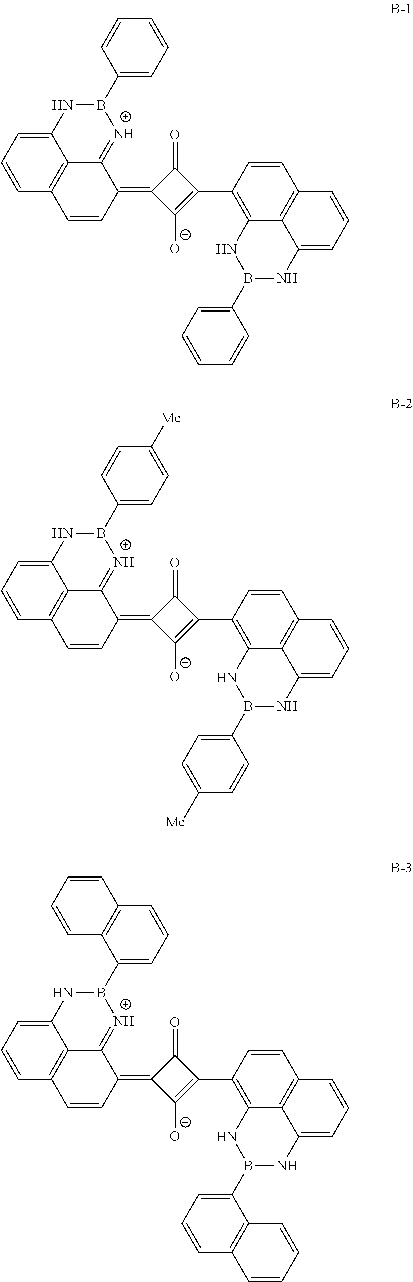 [SMILES: O=C1C(c2ccc3cccc4c3c2NB(c2ccccc2)N4)=C([O-])/C1=c1\ccc2cccc3c2c1=[NH+]B(c1ccccc1)N3 ; Cc1ccc(B2Nc3cccc4ccc(C5=C([O-])/C(=c6\ccc7cccc8c7c6=[NH+]B(c6ccc(C)cc6)N8)C5=O)c(c34)N2)cc1 ; O=C1C(c2ccc3cccc4c3c2NB(c2cccc3ccccc23)N4)=C([O-])/C1=c1\ccc2cccc3c2c1=[NH+]B(c1cccc2ccccc12)N3]

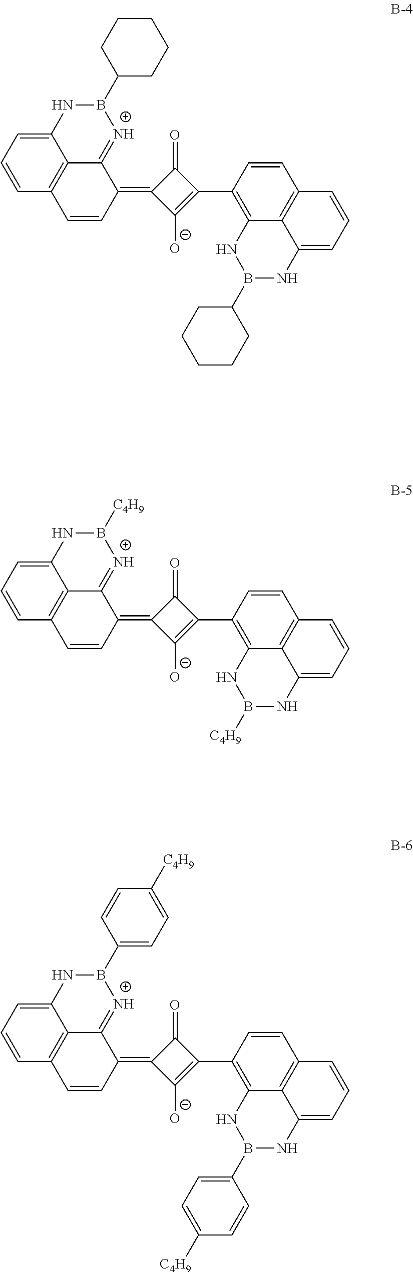

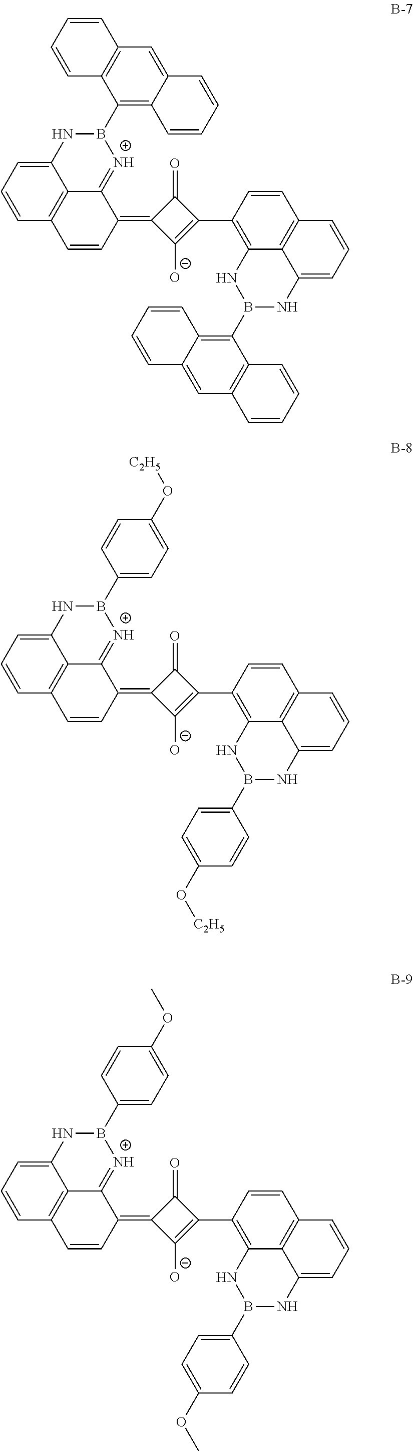 [SMILES: O=C1C(c2ccc3cccc4c3c2NB(c2c3ccccc3cc3ccccc23)N4)=C([O-])/C1=c1\ccc2cccc3c2c1=[NH+]B(c1c2ccccc2cc2ccccc12)N3 ; CCOc1ccc(B2Nc3cccc4ccc(C5=C([O-])/C(=c6\ccc7cccc8c7c6=[NH+]B(c6ccc(OCC)cc6)N8)C5=O)c(c34)N2)cc1 ; COc1ccc(B2Nc3cccc4ccc(C5=C([O-])/C(=c6\ccc7cccc8c7c6=[NH+]B(c6ccc(OC)cc6)N8)C5=O)c(c34)N2)cc1]

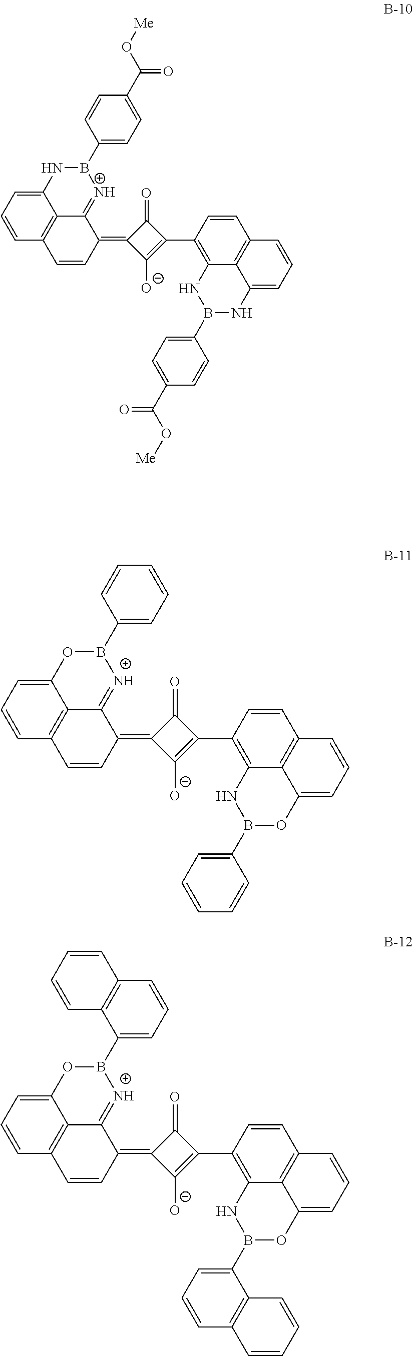 [SMILES: COC(=O)c1ccc(B2Nc3cccc4ccc(C5=C([O-])/C(=c6\ccc7cccc8c7c6=[NH+]B(c6ccc(C(=O)OC)cc6)N8)C5=O)c(c34)N2)cc1 ; O=C1C(c2ccc3cccc4c3c2NB(c2ccccc2)O4)=C([O-])/C1=c1\ccc2cccc3c2c1=[NH+]B(c1ccccc1)O3 ; O=C1C(c2ccc3cccc4c3c2NB(c2cccc3ccccc23)O4)=C([O-])/C1=c1\ccc2cccc3c2c1=[NH+]B(c1cccc2ccccc12)O3]

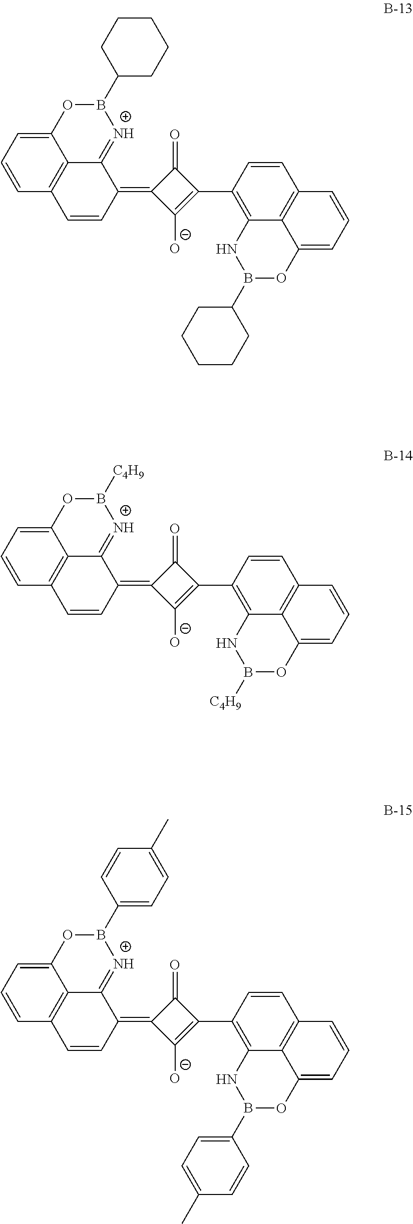

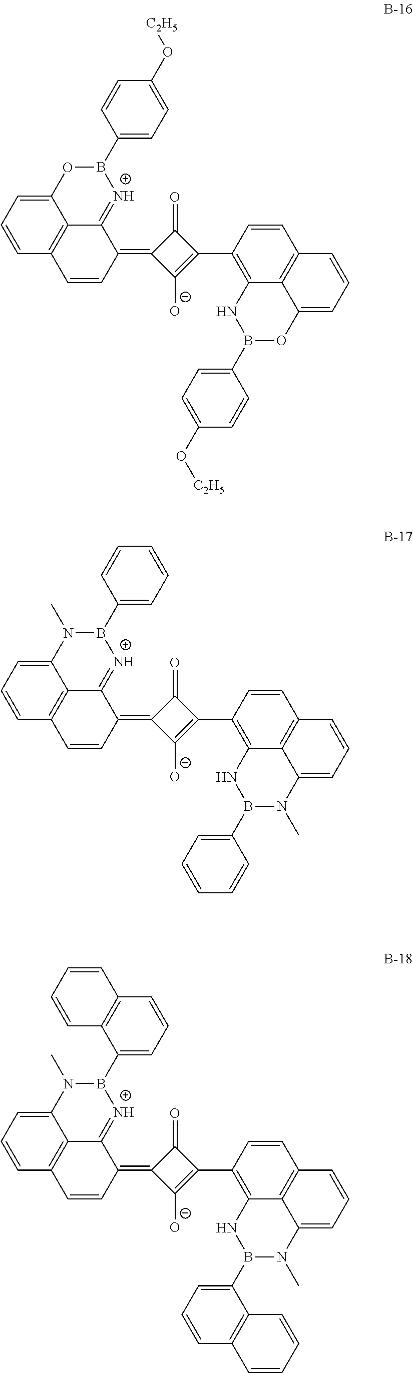 [SMILES: CCOc1ccc(B2Nc3c(C4=C([O-])/C(=c5\ccc6cccc7c6c5=[NH+]B(c5ccc(OCC)cc5)O7)C4=O)ccc4cccc(c34)O2)cc1 ; CN1B(c2ccccc2)Nc2c(C3=C([O-])/C(=c4\ccc5cccc6c5c4=[NH+]B(c4ccccc4)N6C)C3=O)ccc3cccc1c23 ; CN1B(c2cccc3ccccc23)Nc2c(C3=C([O-])/C(=c4\ccc5cccc6c5c4=[NH+]B(c4cccc5ccccc45)N6C)C3=O)ccc3cccc1c23]

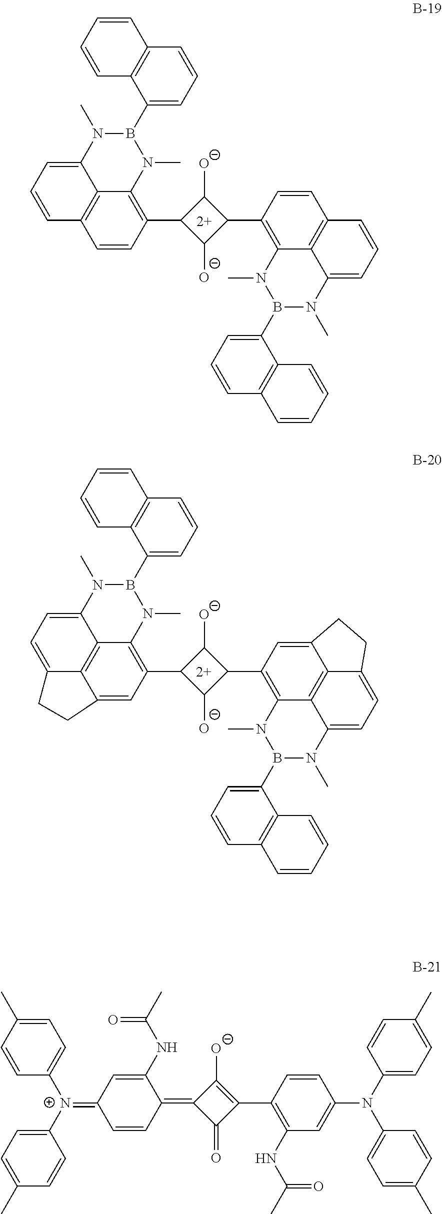 [SMILES: CN1B(c2cccc3ccccc23)N(C)c2c(C3C([O-])C(c4ccc5cccc6c5c4N(C)B(c4cccc5ccccc45)N6C)C3[O-])ccc3cccc1c23 ; CN1B(c2cccc3ccccc23)N(C)c2c(C3C([O-])C(c4cc5c6c(ccc7c6c4N(C)B(c4cccc6ccccc46)N7C)CC5)C3[O-])cc3c4c(ccc1c24)CC3 ; CC(=O)NC1=CC(=[N+](c2ccc(C)cc2)c2ccc(C)cc2)C=C/C1=C1\C(=O)C(c2ccc(N(c3ccc(C)cc3)c3ccc(C)cc3)cc2NC(C)=O)=C1[O-]]

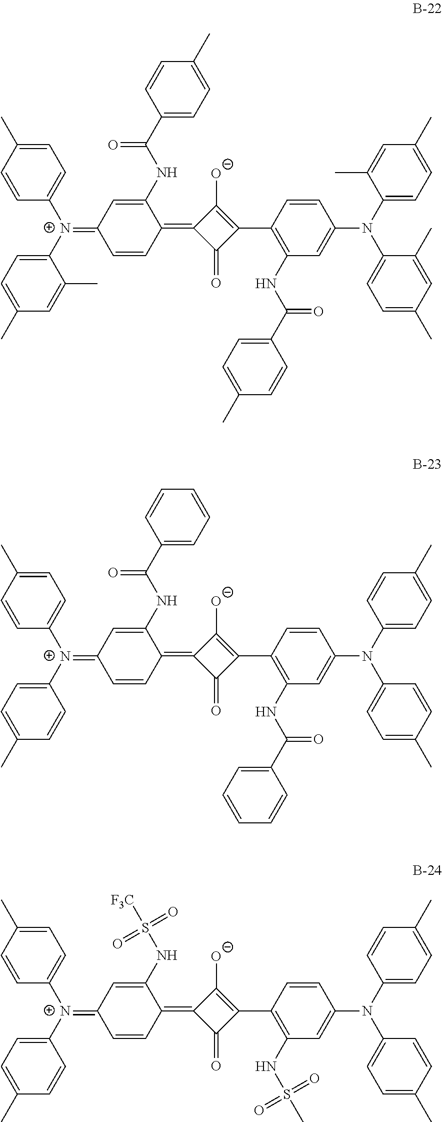 [SMILES: Cc1ccc(C(=O)NC2=CC(=[N+](\c3ccc(C)cc3)c3ccc(C)cc3C)/C=CC/2=C2\C(=O)C(c3ccc(N(c4ccc(C)cc4C)c4ccc(C)cc4C)cc3NC(=O)c3ccc(C)cc3)=C2[O-])cc1 ; Cc1ccc(N(c2ccc(C)cc2)c2ccc(C3=C([O-])/C(=C4/C=CC(=[N+](c5ccc(C)cc5)c5ccc(C)cc5)C=C4NC(=O)c4ccccc4)C3=O)c(NC(=O)c3ccccc3)c2)cc1 ; Cc1ccc(N(c2ccc(C)cc2)c2ccc(C3=C([O-])/C(=C4/C=CC(=[N+](c5ccc(C)cc5)c5ccc(C)cc5)C=C4NS(=O)(=O)C(F)(F)F)C3=O)c(NS(C)(=O)=O)c2)cc1]

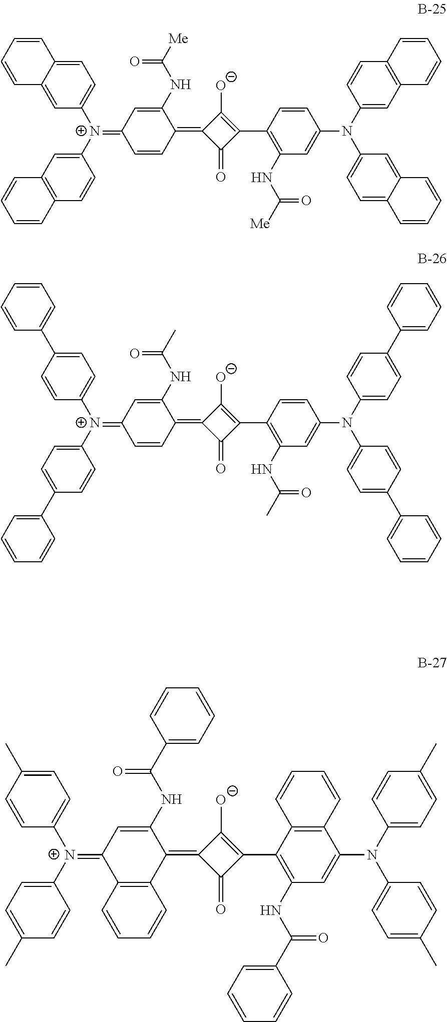 [SMILES: CC(=O)NC1=CC(=[N+](c2ccc3ccccc3c2)c2ccc3ccccc3c2)C=C/C1=C1\C(=O)C(c2ccc(N(c3ccc4ccccc4c3)c3ccc4ccccc4c3)cc2NC(C)=O)=C1[O-] ; CC(=O)NC1=CC(=[N+](c2ccc(-c3ccccc3)cc2)c2ccc(-c3ccccc3)cc2)C=C/C1=C1\C(=O)C(c2ccc(N(c3ccc(-c4ccccc4)cc3)c3ccc(-c4ccccc4)cc3)cc2NC(C)=O)=C1[O-] ; Cc1ccc(N(c2ccc(C)cc2)c2cc(NC(=O)c3ccccc3)c(C3=C([O-])/C(=C4\C(NC(=O)c5ccccc5)=CC(=[N+](c5ccc(C)cc5)c5ccc(C)cc5)c5ccccc54)C3=O)c3ccccc23)cc1]

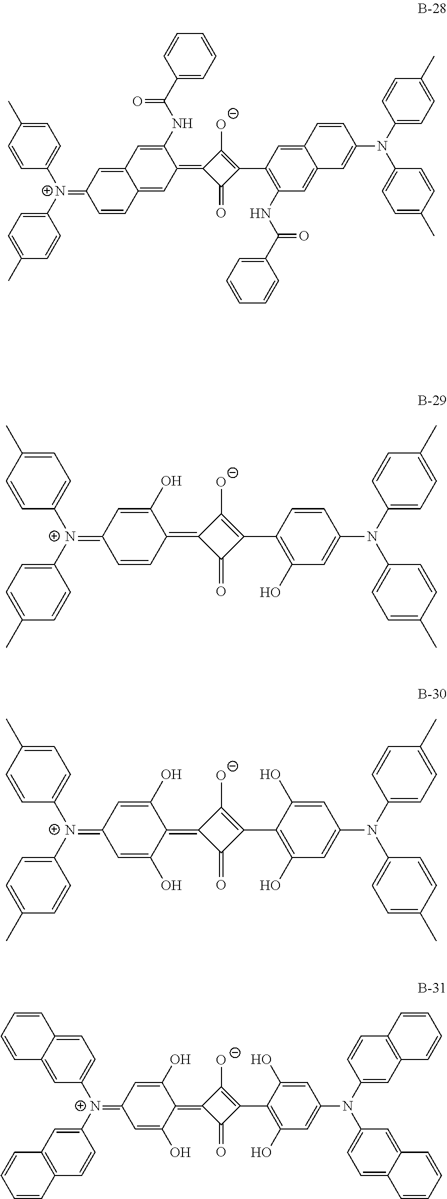 [SMILES: Cc1ccc(N(c2ccc(C)cc2)c2ccc3cc(C4=C([O-])/C(=c5/cc6c(cc5NC(=O)c5ccccc5)=CC(=[N+](c5ccc(C)cc5)c5ccc(C)cc5)C=C6)C4=O)c(NC(=O)c4ccccc4)cc3c2)cc1 ; Cc1ccc(N(c2ccc(C)cc2)c2ccc(C3=C([O-])/C(=C4/C=CC(=[N+](c5ccc(C)cc5)c5ccc(C)cc5)C=C4O)C3=O)c(O)c2)cc1 ; Cc1ccc(N(c2ccc(C)cc2)c2cc(O)c(C3=C([O-])C(=C4C(O)=CC(=[N+](c5ccc(C)cc5)c5ccc(C)cc5)C=C4O)C3=O)c(O)c2)cc1 ; O=C1C(=C2C(O)=CC(=[N+](c3ccc4ccccc4c3)c3ccc4ccccc4c3)C=C2O)C([O-])=C1c1c(O)cc(N(c2ccc3ccccc3c2)c2ccc3ccccc3c2)cc1O]

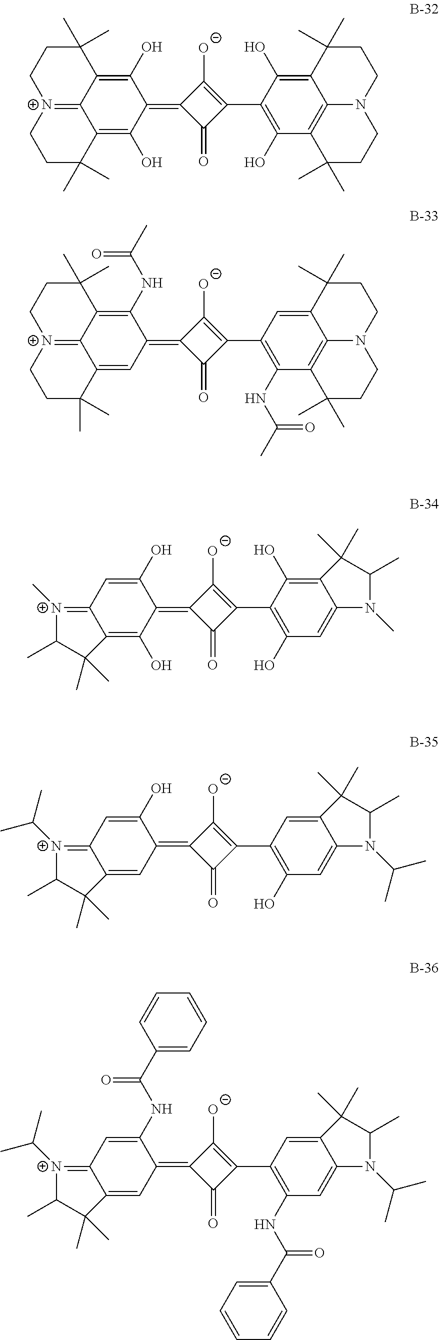

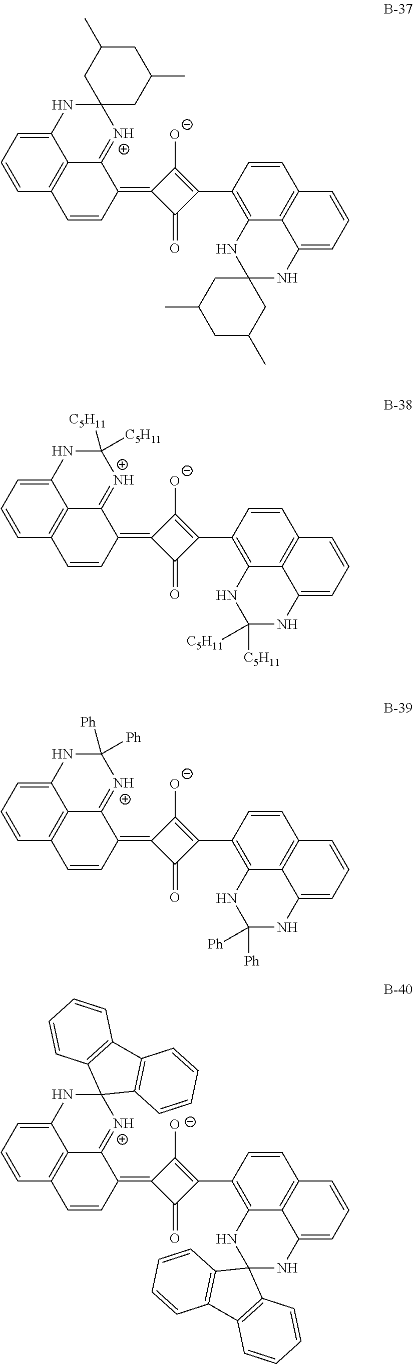

From the viewpoint of dispersibility and temporal stability, the squarylium dye represented by Formula 1 is preferably Specific Example B-1, Specific Example B-3, or Specific Example B-27, more preferably Specific Example B-1 or Specific Example B-3, and even more preferably Specific Example B-1.

It is preferable that the squarylium dye represented by Formula 1 be dispersed in the form of particles in the ink. From the viewpoint of light resistance, the volume-average particle size of the squarylium dye represented by Formula 1 is preferably 10 nm or more, more preferably 15 nm or more, even more preferably 20 nm or more, and particularly preferably 50 nm or more. From the viewpoint of dispersibility and jettability, the volume-average particle size of the squarylium dye represented by Formula 1 is preferably 400 nm or less, more preferably 300 nm or less, and even more preferably 200 nm or less.

In a case where the squarylium dye is coated with a dispersant or the like, the volume-average particle size of the squarylium dye refers to the volume-average particle size of the coated squarylium dye.

The volume-average particle size can be measured by a dynamic light scattering method using Zetasizer Nano ZS (manufactured by Malvern Panalytical Ltd) as a measuring device.

It is preferable that the squarylium dye be dispersed using a disperser. Examples of the disperser include a circulation-type beads mill, a ball mill, a sand mill, an attritor, a roll mill, an agitator, a Henschel mixer, a colloid mill, an ultrasonic homogenizer, a pearl mill, a wet-type jet mill, and a paint shaker.

The content of the squarylium dye represented by Formula 1 with respect to the total mass of the ink is preferably 0.1% by mass to 20% by mass, more preferably 0.1% by mass to 10% by mass, and even more preferably 0.3% by mass to 7% by mass.

(Polymerizable Compound)

The ink according to the present disclosure contains polymerizable compounds. The ink may contain one polymerizable compound or two or more polymerizable compounds.

Examples of the polymerizable compounds include a photopolymerizable compound having a polymerization reaction that proceeds by light irradiation, and a thermopolymerizable compound having a polymerization reaction that proceeds by heating or infrared irradiation. Examples of the photopolymerizable compound include a polymerizable compound having a radically polymerizable group that can be radically polymerized (that is, a radically polymerizable compound) and a polymerizable compound having a cationically polymerizable group that can be cationically polymerized (that is, a cationically polymerizable compound). As the polymerizable compounds, among these, a photopolymerizable compound is preferable, and a radically polymerizable compound is more preferable.

The radically polymerizable compound is preferably an ethylenically unsaturated compound having an ethylenically unsaturated group. Examples of the ethylenically unsaturated compound include a monofunctional ethylenically unsaturated compound and a polyfunctional ethylenically unsaturated compound.

The monofunctional ethylenically unsaturated compound is a compound having one ethylenically unsaturated group. Examples thereof include a monofunctional (meth)acrylate, a monofunctional (meth)acrylamide, a monofunctional aromatic vinyl compound, a monofunctional vinyl ether, and a monofunctional N-vinyl compound.

Examples of the monofunctional (meth)acrylate include methyl (meth)acrylate, ethyl (meth)acrylate, propyl (meth)acrylate, n-butyl (meth)acrylate, hexyl (meth)acrylate, 2-ethylhexyl (meth)acrylate, tert-octyl (meth)acrylate, isoamyl (meth)acrylate, decyl (meth)acrylate, isodecyl (meth)acrylate, lauryl (meth)acrylate, stearyl (meth)acrylate, isostearyl (meth)acrylate, cyclohexyl (meth)acrylate, 4-n-butylcyclohexyl (meth)acrylate, 4-tert-butylcyclohexyl (meth)acrylate, bornyl (meth)acrylate, isobornyl (meth)acrylate, 2-ethylhexyldiglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, 2-(2-methoxyethoxy)ethyl (meth)acrylate, 2-(2-butoxyethoxy)ethyl (meth)acrylate, ethyl carbitol (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, 2-phenoxymethyl (meth)acrylate, 2-phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, 3-hydroxybutyl (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, polyethylene oxide (meth)acrylate, polyethylene oxide monoalkyl ether (meth)acrylate, dipropylene glycol (meth)acrylate, polypropylene oxide monoalkyl ether (meth)acrylate, 2-methacryloyloxyethyl succinate, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctylethyl (meth)acrylate, 2-hydroxy-3-phenoxypropyl (meth)acrylate, ethylene oxide (EO)-modified phenol (meth)acrylate, EO-modified cresol (meth)acrylate, EO-modified nonylphenol (meth)acrylate, propylene oxide (PO)-modified nonylphenol (meth)acrylate, EO-modified-2-ethylhexyl (meth)acrylate, dicyclopentenyl (meth)acrylate, dicyclopentenyloxyethyl (meth)acrylate, dicyclopentanyl (meth)acrylate, (3-ethyl-3-oxetanylmethyl) (meth)acrylate, phenoxyethylene glycol (meth)acrylate, and cyclic trimethylolpropane formal (meth)acrylate.

Examples of the monofunctional (meth)acrylamide include (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, and (meth)acryloylmorpholine.

Examples of the monofunctional aromatic vinyl compound include styrene, dimethylstyrene, trimethylstyrene, isopropylstyrene, chloromethylstyrene, methoxystyrene, acetoxystyrene, chlorostyrene, dichlorostyrene, bromostyrene, vinyl benzoic acid methyl ester, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allyl styrene, isopropenyl styrene, butenyl styrene, octenyl styrene, 4-t-butoxycarbonyl styrene, and 4-t-butoxystyrene.

Examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexyl methyl vinyl ether, 4-methylcyclohexyl methyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Examples of the monofunctional N-vinyl compound include N-vinyl-s-caprolactam and N-vinylpyrrolidone.

From the viewpoint of improving curing properties, the monofunctional ethylenically unsaturated compound is preferably a compound having a ring structure. Examples of the monofunctional ethylenically unsaturated compound having a ring structure include monofunctional (meth)acrylates having a ring structure such as cyclohexyl (meth)acrylate, 4-n-butylcyclohexyl (meth)acrylate, 4-tert-butylcyclohexyl (meth)acrylate, bomyl (meth)acrylate, isobornyl (meth)acrylate, benzyl (meth)acrylate, 4-butylphenyl (meth)acrylate, phenyl (meth)acrylate, 2,4,5-tetramethylphenyl (meth)acrylate, 4-chlorophenyl (meth)acrylate, 2-phenoxymethyl (meth)acrylate, 2-phenoxyethyl (meth)acrylate, dicyclopentenyl (meth)acrylate, dicyclopentenyloxyethyl (meth)acrylate, dicyclopentanyl (meth)acrylate, (3-ethyl-3-oxetanylmethyl) (meth)acrylate, phenoxyethylene glycol (meth)acrylate, and cyclic trimethylolpropane formal (meth)acrylate; monofunctional aromatic vinyl compounds; monofunctional vinyl ethers having a ring structure such as cyclohexyl vinyl ether, cyclohexyl methyl vinyl ether, 4-methylcyclohexyl methyl vinyl ether, benzyl vinyl ether, dicyclopentenyl vinyl ether, 2-dicyclopentenoxyethyl vinyl ether, phenyl ethyl vinyl ether, and phenoxypolyethylene glycol vinyl ether; and monofunctional N-vinyl compounds having a ring structure such as N-vinyl-s-caprolactam and N-vinylpyrrolidone.

Particularly, from the viewpoint of preventing oxygen from hindering polymerization, it is preferable that the monofunctional ethylenically unsaturated compound further have a heteroatom. Examples of the monofunctional ethylenically unsaturated compound having a ring structure and a heteroatom include N-vinyl-s-caprolactam and N-vinylpyrrolidone.

The polyfunctional ethylenically unsaturated compound is a compound having two or more ethylenically unsaturated groups, and examples thereof include a polyfunctional (meth)acrylate and a polyfunctional vinyl ether.

Examples of the polyfunctional (meth)acrylate include ethylene glycol di(meth)acrylate, diethylene glycol di(meth)acrylate, triethylene glycol di(meth)acrylate, propylene glycol di(meth)acrylate, dipropylene glycol di(meth)acrylate, tripropylene glycol di(meth)acrylate, polyethylene glycol di(meth)acrylate, polypropylene glycol di(meth)acrylate, butylene glycol di(meth)acrylate, tetraethylene glycol di(meth)acrylate, neopentyl glycol di(meth)acrylate, 3-methyl-1,5-pentanediol di(meth)acrylate, hexanediol di(meth)acrylate, heptanediol di(meth)acrylate, EO-modified neopentyl glycol di(meth)acrylate, PO-modified neopentyl glycol di(meth)acrylate, EO-modified hexanediol di(meth)acrylate, PO-modified hexanediol di(meth)acrylate, octanediol di(meth)acrylate, nonanediol di(meth)acrylate, decanediol di(meth)acrylate, dodecanediol di(meth)acrylate, 1,6-hexanediol di(meth)acrylate, glycerin di(meth)acrylate, pentaerythritol di(meth)acrylate, ethylene glycol diglycidyl ether di(meth)acrylate, diethylene glycol diglycidyl ether di(meth)acrylate, tricyclodecanedimethanol di(meth)acrylate, trimethylolethane tri(meth)acrylate, trimethylolpropane tri(meth)acrylate, trimethylolpropane EO-added tri(meth)acrylate, pentaerythritol tri(meth)acrylate, pentaerythritol tetra(meth)acrylate, dipentaerythritol tetra(meth)acrylate, dipentaerythritol penta(meth)acrylate, dipentaerythritol hexa(meth)acrylate, tri(meth)acryloyloxyethoxytrimethylolpropane, glycerin polyglycidyl ether poly(meth)acrylate, tris(2-acryloyloxyethyl) isocyanurate, and 2-(2-vinyloxyethoxy)ethyl (meth)acrylate.

Examples of the polyfunctional vinyl ether include 1,4-butanediol divinyl ether, ethylene glycol divinyl ether, diethylene glycol divinyl ether, triethylene glycol divinyl ether, polyethylene glycol divinyl ether, propylene glycol divinyl ether, butylene glycol divinyl ether, hexanediol divinyl ether, 1,4-cyclohexanedimethanol divinyl ether, bisphenol A alkylene oxide divinyl ether, bisphenol F alkylene oxide divinyl ether, trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, EO-added trimethylolpropane trivinyl ether, PO-added trimethylolpropane trivinyl ether, EO-added ditrimethylolpropane tetravinyl ether, PO-added ditrimethylolpropane tetravinyl ether, EO-added pentaerythritol tetravinyl ether, PO-added pentaerythritol tetravinyl ether, EO-added dipentaerythritol hexavinyl ether, and PO-added dipentaerythritol hexavinyl ether.

From the viewpoint of improving curing properties, the polyfunctional ethylenically unsaturated compound is preferably a compound having an oxygen atom. The ratio of the number of oxygen atoms to the number of carbon atoms contained in one molecule of the polyfunctional ethylenically unsaturated compound is preferably 0.2 or more, and more preferably 0.3 or more. The upper limit of the ratio is not particularly limited, but is, for example, 0.5. Examples of the compound in which the ratio of the number of oxygen atoms to the number of carbon atoms contained in one molecule is 0.2 or more include polyethylene glycol diacrylate.

The polymerizable compounds may be the commercially available products described in Shinzo Yamashita, “Handbook of Crosslinking Agents” (1981, Taiseisha); Kiyomi Kato, “UV-EB Curing Handbook (Raw Materials)” (1985, Kobunshi Kankokai); RadTech Japan, “Application and Market of UV-EB Curing Technology”, p. 79, (1989, CMC); Eiichiro Takiyama, “Polyester Resin Handbook”, (1988, NIKKAN KOGYO SHIMBUN, LTD.), and the like.

From the viewpoint of curing properties, the molecular weight of the polymerizable compounds is preferably 100 to 1,000, more preferably 100 to 800, and even more preferably 150 to 700.

The ink according to the present disclosure preferably contains polyfunctional polymerizable compounds and more preferably contains a monofunctional polymerizable compound and a polyfunctional polymerizable compound, as polymerizable compounds. Incorporating polyfunctional polymerizable compounds into the ink makes it possible to record an image having excellent curing properties. Furthermore, incorporating polyfunctional polymerizable compounds into the ink makes it possible to suppress the phenomenon (so-called migration) where the unreacted polymerizable compounds are transferred to the outside from the article with a recorded image. Particularly, the ink containing a polyfunctional polymerizable compound is excellent because such an ink is applicable to packaging materials in the field of food packaging and cosmetic packaging where the safety of substrates is strictly required.

From the viewpoint of curing properties, the proportion of the polyfunctional polymerizable compounds in the polymerizable compounds contained in the ink is preferably 50% by mass or more, and more preferably 60% by mass or more. The upper limit of the proportion of the polyfunctional polymerizable compounds in the polymerizable compounds contained in the ink is not particularly limited, and may be 100% by mass.

From the viewpoint of curing properties, the content of the polymerizable compounds with respect to the total mass of the ink is preferably 60% by mass to 95% by mass, more preferably 70% by mass to 95% by mass, and even more preferably 75% by mass to 95% by mass.

In the present disclosure, at least one of the polymerizable compounds is preferably a polymerizable compound having a solubility parameter (hereinafter, also called “SP value”) of 18 MPa^{1/2} or more. The content of the polymerizable compound having an SP value of 18 MPa^{1/2} or more with respect to the total mass of the ink is preferably 10% by mass to 40% by mass, and more preferably 20% by mass to 35% by mass.

At least one of the polymerizable compounds preferably has an SP value of 18 MPa^{1/2} to 40 MPa^{1/2}, and more preferably has an SP value of 18 MPa^{1/2} to 30 MPa^{1/2}. The content of the polymerizable compound having an SP value of 18 MPa^{1/2} or more with respect to the total mass of the polymerizable compounds is preferably 20% by mass to 40% by mass, and more preferably 30% by mass to 40% by mass.

The polymerizable compound having an SP value of 18 MPa^{1/2} or more has high polarity and tends to exist at the air interface in the ink. Therefore, in the ink film formed by landing ink droplets on a substrate and then drying the ink droplets, many polymerizable compounds having an SP value of 18 MPa^{1/2} or more are on the surface of the ink film. Within the surface of the ink film, polymerization is likely to be hindered by oxygen. Therefore, allowing many polymerizable compounds to present on the surface of the ink film makes it possible to improve the curing properties within the surface of the ink film. As a result, peeling of the surface of the ink film can be suppressed.

The polymerizable compound having an SP value of 18 MPa^{1/2} or more is preferably a radically polymerizable compound, and more preferably an ethylenically unsaturated compound. The polymerizable compound having an SP value of 18 MPa^{1/2} or more may be a monofunctional polymerizable compound or a polyfunctional polymerizable compound. From the viewpoint of flexibility, the polymerizable compound having an SP value of 18 MPa^{1/2} or more is more preferably a monofunctional polymerizable compound.

In the present disclosure, for the SP value, the Hansen solubility parameters are used. The Hansen solubility parameters are obtained by dividing the solubility parameters introduced by Hildebrand into three components, a dispersion element δd, a polarity element δp, and a hydrogen bond element δh, and expressing the parameters in a three-dimensional space. In the present disclosure, the SP value is a value that is represented by δ [MPa^{1/2}] and calculated using the following formula.

δ[MPa^{1/2}]=(δd²+δp²+δh²)^{1/2}

The dispersion element δd, the polarity element δp, and the hydrogen bond element δh of various substances have been found by Hansen and his successors, and are described in detail in the Polymer Handbook (fourth edition), VII-698 to 711.

For many solvents and resins, the values of Hansen solubility parameters have been investigated and are listed, for example, in Wesley L. Archer, “Industrial Solvents Handbook”.

Specific examples of the polymerizable compound with 18 MPa^{1/2} or more will be shown below.

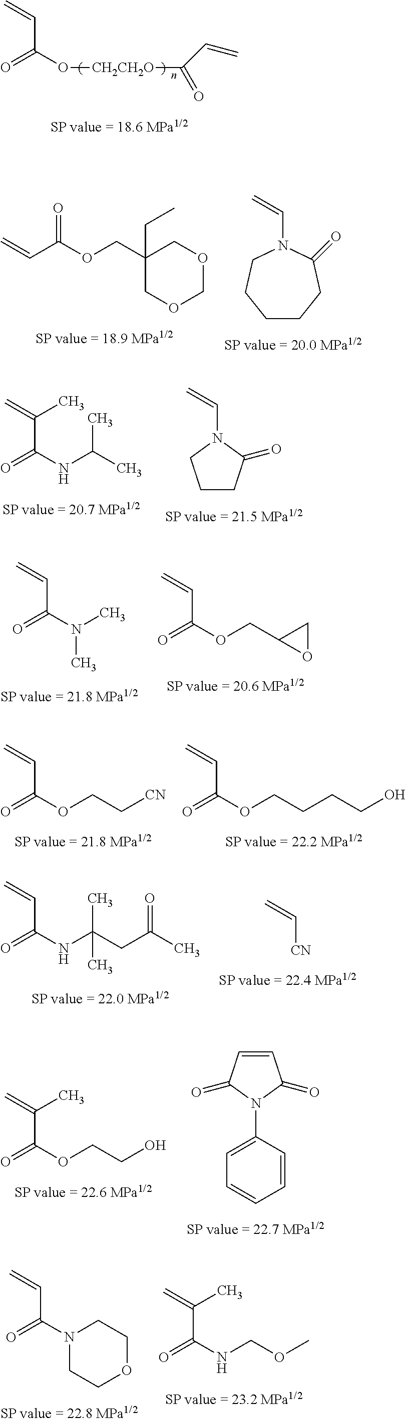

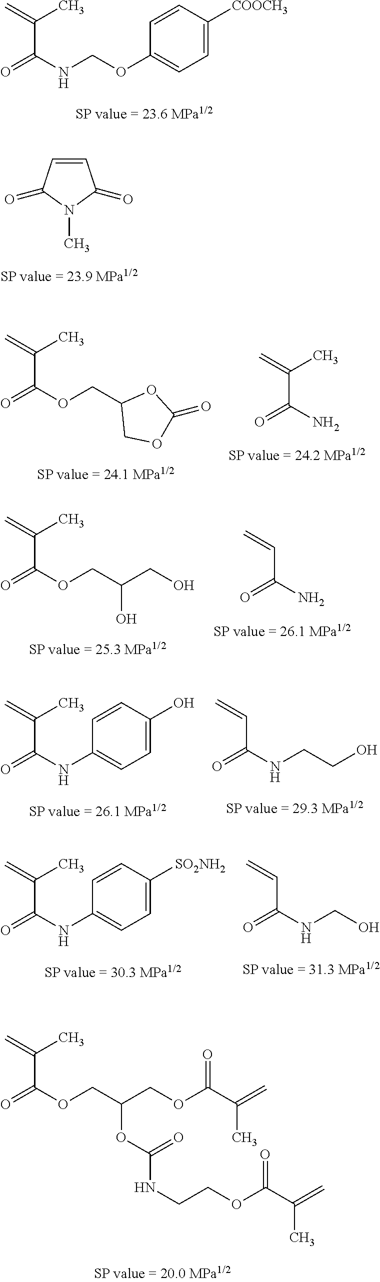

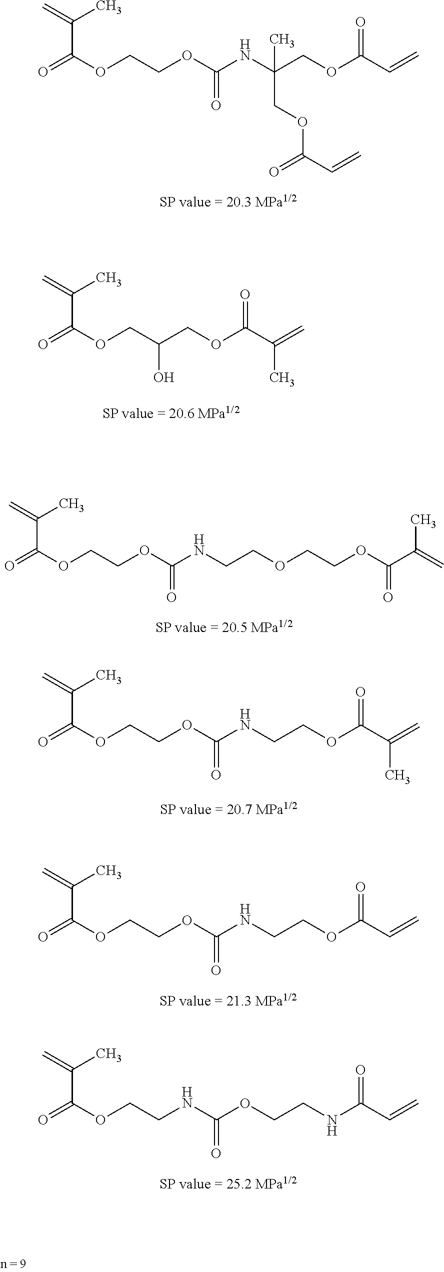

As the polymerizable compound with 18 MPa^{1/2} or more, among the above, cyclic trimethylolpropane formal acrylate, polyethylene glycol diacrylate (number of moles of ethylene oxide added: 9), or N-vinylcaprolactam is preferable.

(Synergist)

The ink according to the present disclosure contains a synergist having at least one group selected from the group consisting of a carboxy group and a sulfo group and at least one ring selected from the group consisting of an aromatic ring and a heteroaromatic ring.

In the ink, the hydrogen atom of the carboxy group and the sulfo group contained in the synergist may be dissociated, or the carboxy group and the sulfo group may be in the form of a salt. The cation forming the salt is preferably an ammonium ion or an alkali metal ion (for example, a lithium ion, a sodium ion, or a potassium ion), and more preferably an alkali metal ion.

The aromatic ring and the heteroaromatic ring contained in the synergist may be a monocyclic ring or a fused ring. From the viewpoint of further enhancing the π-π interaction with the squarylium dye, it is preferable that the synergist have at least one fused ring.

Examples of the aromatic ring and the heteroaromatic ring include a benzene ring, a naphthalene ring, a pentalene ring, an indene ring, an azulene ring, a heptalene ring, an indecene ring, a perylene ring, a pentacene ring, an acenaphthalene ring, a phenanthrene ring, an anthracene ring, a naphthacene ring, a chrysene ring, a triphenylene ring, a fluorene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridazine ring, a triazine ring, an indolidine ring, an indole ring, an isoindole ring, a benzofuran ring, a benzothiophene ring, an isobenzofuran ring, a quinolizine ring, a quinoline ring, a phthalazine ring, a naphthyridine ring, a quinoxaline ring, a quinoxazoline ring, an isoquinoline ring, a carbazole ring, a phenanthridine ring, an acridine ring, a phenanthroline ring, a thianthrene ring, a chromene ring, a xanthene ring, a phenoxathiin ring, a phenothiazine ring, a phenoxazine ring, an acridone ring, an anthraquinone ring, and a phenazine ring. As the aromatic ring and the heteroaromatic ring, among these, an isoindole ring, a triazine ring, or an anthraquinone ring is preferable.

In the present disclosure, the synergist means a colorant derivative having a structure derived from a dye in the molecule, and is a compound having a molecular weight of less than 1,000.

The synergist is preferably represented by Formula 3.

P—[R¹⁰—X¹⁰]m (3)

In Formula 3, P represents a group having at least one ring selected from the group consisting of an aromatic ring and a heteroaromatic ring, R¹⁰ represents a divalent linking group, and X¹⁰ each independently represents a carboxy group or a sulfo group. m represents the maximum integer that can be substituted with P.

The group having at least one ring selected from the group consisting of an aromatic ring and a heteroaromatic ring may be a colorant residue.

The colorant residue means a group obtained by removing m pieces of hydrogen atoms from a colorant.

[P]

Examples of P include a diketopyrrolopyrrole-based colorant; an azo-based colorant such as azo, disazo, or polyazo; a phthalocyanine-based colorant; an anthraquinone-based colorant such as diaminodianthraquinone, anthrapyrimidine, flavanthrone, anthanthrone, indanthrone, pyrathrone, or violanthrone; a quinacridone-based colorant; a dioxazine-based colorant; a perinone-based colorant; a perylene-based colorant; a thioindigo-based colorant; an isoindoline-based colorant; an isoindolinone-based colorant; a quinophthalone-based colorant; and residues of a threne-based colorant and a metal complex-based colorant.

As P, among the above, from the viewpoint of improving dispersibility and temporal stability, a diketopyrrolopyrrole-based colorant, a phthalocyanine-based colorant, an anthraquinone-based colorant, or a dioxazine-based colorant residue is preferable, and a diketopyrrolopyrrole-based colorant, a phthalocyanine-based colorant, or an anthraquinone-based colorant is more preferable.

[R¹⁰]

Examples of R¹⁰ include an alkylene group, an arylene group, a divalent group selected from the group consisting of —O—, —S—, —C═O—, —NR³⁰—, —CONR³⁰—, —SO₂NR³⁰, —NR³⁰CO—, and —NR³⁰SO₂—, a divalent group obtained by combining two or more of these, and a single bond. R³⁰ represents a hydrogen atom or an alkyl group.

Among the above, a single bond is preferable as R¹⁰.

[X¹⁰]

X¹⁰ is preferably a sulfo group. A plurality of X¹⁰'s may be the same as or different from each other. It is preferable that X¹⁰'s be the same as each other.

[m]

m is preferably 1 to 10, more preferably 1 to 5, and even more preferably 1 to 3.

The synergist may be a commercially available product. Examples of the commercially available product include EFKA 6745 (manufactured by BASF SE), SOLSPERSE 5000S and SOLSPERSE 12000S (manufactured by Lubrizol Japan Limited), Direct 106 (manufactured by Tokyo Chemical Industry Co., Ltd.), Tilosperse 5006 and Tilosperse 5007 (manufactured by TIANLONG CHEMICALS CO., LTD.), BYK-SYNERGIST 2100 (manufactured by BYK-Chemie GmbH.), NEWKALGEN PS-P and TAKESURF A45-K (TAKEMOTO OIL & FAT Co., Ltd.), and 2,6-naphthalenedicarboxylic acid (manufactured by Tokyo Chemical Industry Co., Ltd.).

The ink may contain one synergist or two or more synergists.

From the viewpoint of improving dispersibility and temporal stability, the content of the synergist with respect to the total mass of the ink is preferably 0.001% by mass to 0.2% by mass, and more preferably 0.005% by mass to 0.1% by mass.

From the viewpoint of improving dispersibility and temporal stability, the content of the synergist with respect to the total mass of the squarylium dye is preferably 0.10% by mass to 20% by mass, more preferably 0.12% by mass to 15% by mass, and even more preferably 0.15% by mass to 12% by mass.

(Dispersant)

The ink according to the present disclosure contains a dispersant. The dispersant has a function of dispersing the squarylium dye represented by Formula 1.

The dispersant is preferably a polymer having a molecular weight of 1,000 or more. The polymer may be either a random copolymer or a block copolymer. The dispersant preferably has a basic functional group or an acidic functional group, and more preferably has a basic functional group. In the present disclosure, the synergist has at least one group selected from the group consisting of a carboxy group and a sulfo group. Therefore, in a case where the dispersant has a basic functional group, the synergist is easily adsorbed onto the dispersant due to the acid-base interaction. Due to the steric repulsion between the dispersantS, the squarylium dye can be stably dispersed in the ink.

Examples of the basic functional group include an amino group, an amide group, and an imino group. The dispersant may have only one basic functional group or two or more basic functional groups.

The dispersant may be a commercially available product. Examples of the commercially available product include a SOLSPERSE (registered trademark) series (examples: SOLSPERSE 16000, 21000, 32000, 35000, 41000, 41090, 43000, 44000, 46000, 54000, 71000, and the like) from The Lubrizol Corporation, a DISPERBYK (registered trademark) series (examples: DISPERBYK 102, 110, 111, 118, 170, 190, 194N, 2015, 2090, 2096, and the like) from BYK-Chemie GmbH., a TEGO (registered trademark) Dispers series (examples: TEGO Dispers 610, 610S, 630, 651, 655, 750W. 755W, and the like) from Evonik industries, a DISPARLON (registered trademark) series (examples: DA-375, DA-1200, and the like) from Kusumoto Chemicals, Ltd., and a FLOREN series (examples: WK-13E, G-700, G-900, GW-1500, GW-1640, WK-13E, and the like) from KYOEISHA CHEMICAL Co., LTD.

The weight-average molecular weight of the dispersant is preferably 1,000 to 100,000, and more preferably 20,000 to 100,000. The weight-average molecular weight means a value measured by gel permeation chromatography (GPC). For THE measurement by gel permeation chromatography (GPC), HLC (registered trademark)-8020GPC (manufactured by TOSOH CORPORATION) is used as a measuring device, three TSKgel (registered trademark) Super Multipore HZ-H (4.6 mm ID×15 cm, manufactured by TOSOH CORPORATION) columns are used as columns, and tetrahydrofuran (THF) is used as an eluent. The measurement is performed using an RI detector under the conditions of a sample concentration of 0.45% by mass, a flow rate of 0.35 ml/min, a sample injection amount of 10 μl, and a measurement temperature of 40° C. The calibration curve is plotted from 8 samples of “Standard sample TSK standard, polystyrene” manufactured by TOSOH CORPORATION: “F-40”, “F-20”, “F-4”, “F-1”, “A-5000”, “A-2500”, “A-1000”, and “n-propylbenzene”.

From the viewpoint of improving dispersibility and temporal stability of the ink, the base number of the dispersant is preferably 15 mgKOH/g or more, more preferably 20 mgKOH/g or more, and even more preferably 25 mgKOH/g or more. The upper limit of the base number of the dispersant is not particularly limited, but is, for example, 40 mgKOH/g.

In the present disclosure, the base number is a value measured by the perchloric acid method specified by JIS K 2501: 2003. The base number is obtained as milligrams (mg) of potassium hydroxide equivalent to hydrochloric acid or perchloric acid required to neutralize all the basic components contained in 1 g of a sample.

The dispersant having a base number of 15 mgKOH/g or more is preferably a polymer, and more preferably a polymer having polyethyleneimine as the main chain.

From the viewpoint of improving dispersibility and temporal stability of the ink, the content of the dispersant with respect to the total mass of the ink is preferably 0.7% by mass to 5% by mass, and more preferably 0.8% by mass to 4% by mass.

The ratio of the content of the dispersant to the content of the squarylium dye represented by Formula 1 is preferably 0.1 to 20, more preferably 0.2 to 5, and even more preferably 0.5 to 5, based on mass.

(Polymerization Initiator)

It is preferable that the ink according to the present disclosure contain a polymerization initiator. The ink may contain one polymerization initiator or two or more polymerization initiators. In a case where the ink according to the present disclosure contains a radically polymerizable compound as a polymerizable compound, the polymerization initiator is preferably a radical polymerization initiator.

Examples of the radical polymerization initiator include an alkylphenone compound, an acylphosphine compound, an aromatic onium salt compound, an organic peroxide, a thio compound, a hexaarylbiimidazole compound, a ketoxime ester compound, a borate compound, an azinium compound, a metallocene compound, an active ester compound, a carbon halogen bond-containing compound, and an alkylamine compound.

As the polymerization initiator, among the above, at least one compound selected from the group consisting of an acylphosphine compound and a thio compound is preferable, at least one compound selected from the group consisting of an acylphosphine oxide compound and a thioxanthone compound is more preferable, and a combination of an acylphosphine oxide compound and a thioxanthone compound is even more preferable.

Examples of the acylphosphine oxide compound include a monoacylphosphine oxide compound and a bisacylphosphine oxide compound. The acylphosphine oxide compound is preferably a bisacylphosphine oxide compound.

Examples of the monoacylphosphine oxide compound include isobutyryl diphenylphosphine oxide, 2-ethylhexanoyldiphenylphosphine oxide, 2,4,6-trimethylbenzoyldiphenylphosphine oxide, (2,4,6-trimethylbenzoyl)ethoxyphenylphosphine oxide, o-toluyldiphenylphosphine oxide, p-t-butylbenzoyldiphenylphosphine oxide, 3-pyridylcarbonyldiphenylphosphine oxide, acryloyl diphenylphosphine oxide, benzoyl diphenylphosphine oxide, pivaloyl phenylphosphinic acid vinyl ester, adipoyl bisdiphenylphosphine oxide, pivaloyl diphenylphosphine oxide, p-toluyldiphenylphosphine oxide, 4-(t-butyl)benzoyldiphenylphosphine oxide, terephthaloyl bisdiphenylphosphine oxide, 2-methylbenzoyldiphenylphosphine oxide, versatoyl diphenylphosphine oxide, 2-methyl-2-ethylhexanoyldiphenylphosphine oxide, 1-methyl-cyclohexanoyldiphenylphosphine oxide, pivaloyl phenylphosphinic acid methyl ester, and pivaloyl phenylphosphinic acid isopropyl ester.

Examples of the bisacylphosphine oxide compound include bis(2,6-dichlorobenzoyl)phenylphosphine oxide, bis(2,6-dichlorobenzoyl)-2,5-dimethylphenylphosphine oxide, bis(2,6-dichlorobenzoyl)-4-ethoxyphenylphosphine oxide, bis(2,6-dichlorobenzoyl)-4-propylphenylphosphine oxide, bis(2,6-dichlorobenzoyl)-2-naphthylphosphine oxide, bis(2,6-dichlorobenzoyl)-1-naphthylphosphine oxide, bis(2,6-dichlorobenzoyl)-4-chlorophenylphosphine oxide, bis(2,6-dichlorobenzoyl)-2,4-dimethoxyphenylphosphine oxide, bis(2,6-dichlorobenzoyl)decylphosphine oxide, bis(2,6-dichlorobenzoyl)-4-octylphenylphosphine oxide, bis(2,4,6-trimethylbenzoyl)phenylphosphine oxide, bis(2,4,6-trimethylbenzoyl)-2,5-dimethylphenylphosphine oxide, bis(2,6-dichloro-3,4,5-trimethoxybenzoyl)-2,5-dimethylphenylphosphine oxide, bis(2,6-dichloro-3,4,5-trimethoxybenzoyl)-4-ethoxyphenylphosphine oxide, bis(2-methyl-1-naphthoyl)-2,5-dimethylphenylphosphine oxide, bis(2-methyl-1-naphthoyl)-4-ethoxyphenylphosphine oxide, bis(2-methyl-1-naphthoyl)-2-naphthylphosphine oxide, bis(2-methyl-1-naphthoyl)-4-propylphenylphosphine oxide, bis(2-methyl-1-naphthoyl)-2,5-dimethylphenylphosphine oxide, bis(2-methoxy-1-naphthoyl)-4-ethoxyphenylphosphine oxide, bis(2-chloro-1-naphthoyl)-2,5-dimethylphenylphosphine oxide, and bis(2,6-dimethoxybenzoyl)-2,4,4-trimethylpentylphosphine oxide.

As the acylphosphine oxide compound, among the above, bis(2,4,6-trimethylbenzoyl)phenylphosphine oxide (trade name “Omnirad 819”, manufactured by IGM Resins B.V.), 2,4,6-trimethylbenzoyldiphenylphosphine oxide (trade name “Omnirad TPO H”, manufactured by IGM Resins B.V.), or (2,4,6-trimethylbenzoyl)ethoxyphenylphosphine oxide (trade name “Omnirad TPO-L”, manufactured by IGM Resins B.V.) is preferable.

Examples of the thioxanthone compound include thioxanthone, 2-isopropylthioxanthone, 4-isopropylthioxanthone, 2-chlorothioxanthone, 2,4-dichlorothioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di[2-(2-methoxyethoxy)ethoxycarbonyl]thioxanthone, 1-ethoxycarbonyl-3-(1-methyl-1-morpholinoethyl)thioxanthone, 2-methyl-6-dimethoxymethylthioxanthone, 2-methyl-6-(1,1-dimethoxybenzyl)thioxanthone, 2-morpholinomethylthioxanthone, 2-methyl-6-morpholinomethylthioxanthone, n-allylthioxanthone-3,4-dicarboximide, n-octylthioxanthone-3,4-dicarboximide, N-(1,1,3,3-tetramethylbutyl)thioxanthone-3,4-dicarboximide, 1-phenoxythioxanthone, 6-ethoxycarbonyl-2-methoxythioxanthone, 6-ethoxycarbonyl-2-methylthioxanthone, thioxanthone-2-polyethylene glycol ester, and 2-hydroxy-3-(3,4-dimethyl-9-oxo-9H-thioxanthon-2-yloxy)-N,N,N-trimethyl-1-propanaminium chloride.

The thioxanthone compound may be a commercially available product. Examples of the commercially available product include a SPEEDCURE series (examples: SPEEDCURE 7010, SPEEDCURE CPTX, SPEEDCURE ITX, and the like) manufactured by Lambson.

From the viewpoint of improving dispersibility and temporal stability of the ink, the content of the polymerization initiator is preferably 10% by mass or more with respect to the total mass of the ink. The upper limit of the content of the polymerization initiator is not particularly limited, but is, for example, 30% by mass.

(Polymerization Inhibitor)

It is preferable that the ink according to the present disclosure contain a polymerization inhibitor. The ink may contain one polymerization inhibitor or two or more polymerization inhibitors.

Examples of the polymerization inhibitor include a hydroquinone compound, phenothiazine, catechols, alkylphenols, alkylbisphenols, zinc dimethyldithiocarbamate, copper dimethyldithiocarbamate, copper dibutyldithiocarbamate, copper salicylate, a thiodipropionic acid ester, mercaptobenzimidazole, phosphites, a nitrosamine compound, a hindered amine compound, and a nitroxyl radical.

As the polymerization inhibitor, among the above, at least one compound selected from the group consisting of a nitrosamine compound, a hindered amine compound, a hydroquinone compound, and a nitroxyl radical is preferable, and at least one compound selected from the group consisting of a nitrosamine compound, a hydroquinone compound, and a nitroxyl radical is more preferable. It is even more preferable that the polymerization inhibitor include a nitrosamine compound, a hydroquinone compound, and a nitroxyl radical.

Examples of the nitrosamine compound include a N-nitroso-N-phenylhydroxylamine aluminum salt and N-nitroso-N-phenylhydroxylamine. As the nitrosamine compound, among these, a N-nitroso-N-phenylhydroxylamine aluminum salt is preferable.

The hindered amine compound is a compound having a hindered amine structure in the molecule. Examples of the hindered amine compound include the compounds described in JP1986-91257A (JP-S61-91257A). As the hindered amine compound, among these, a derivative of 2,2,6,6-tetramethylpiperidine is preferable which has a structure established by the substitution of all hydrogens on carbons at 2- and 6-positions of piperidine with methyl groups. Examples of the hindered amine compound include 4-benzoyloxy-2,2,6,6-tetramethylpiperidine and 1-(3,5-di-tert-butyl-4-hydroxyphenylpropionyloxyethyl)-4-(3,5-di-tert-butyl-4-hydroxyphenylpropionyloxy)-2,2,6,6-tetramethylpiperidine.

Examples of the hydroquinone compound include hydroquinone, methylhydroquinone, t-butylhydroquinone, and p-methoxyphenol. As the hydroquinone compound, among these, p-methoxyphenol is preferable.

Examples of the nitroxyl radical include 2,2,6,6-tetramethylpiperidine-1-oxyl (TEMPO) and 2,2,6,6-tetramethyl-4-hydroxypiperidine-1-oxyl (TEMPOL). As the nitroxyl radical, among these, 2,2,6,6-tetramethyl-4-hydroxypiperidine-1-oxyl (TEMPOL) is preferable.

From the viewpoint of improving temporal stability of the ink, the content of the polymerization inhibitor with respect to the total mass of the ink is preferably 1% by mass or more, and more preferably 1.5% by mass or more. The upper limit of the content of the polymerization inhibitor is not particularly limited, but is preferably 5% by mass from the viewpoint of polymerization properties.

In a case where the polymerization inhibitor includes a nitrosamine compound, from the viewpoint of improving temporal stability of the ink, the content of the nitrosamine compound with respect to the total mass of the ink is preferably 0.5% by mass to 5% by mass, and more preferably 0.5% by mass to 2% by mass.

In a case where the polymerization inhibitor includes a hydroquinone compound, from the viewpoint of improving temporal stability of the ink, the content of the hydroquinone compound with respect to the total mass of the ink is preferably 0.1% by mass to 5% by mass, and more preferably 0.3% by mass to 1% by mass.

In a case where the polymerization inhibitor includes a nitroxyl radical, from the viewpoint of improving temporal stability of the ink, the content of the nitroxyl radical with respect to the total mass of the ink is preferably 0.1% by mass to 5% by mass, and more preferably 0.2% by mass to 0.8% by mass.

(Sensitizer)

In a case where the ink according to the present disclosure contains a photopolymerization initiator, the ink may contain a sensitizer together with the photopolymerization initiator. In a case where the ink contains a sensitizer, curing properties are improved. Particularly, in a case where an LED light source is used, curing properties are improved. The sensitizer also contributes to the improvement of light resistance of the ink.

A sensitizer is a substance that is electronically excited by absorbing specific active energy rays. The electronically excited sensitizer comes into contact with the photopolymerization initiator and causes actions such as electron migration, energy transfer, and heat generation. As a result, the chemical change of the photopolymerization initiator is facilitated.

Examples of the sensitizer include ethyl 4-(dimethylamino)benzoate (EDB), anthraquinone, a 3-acylcoumarin derivative, terphenyl, styryl ketone, 3-(aroylmethylene)thiazoline, camphorquinone, eosin, rhodamine, erythrosine, a compound represented by General Formula (i) described in JP2010-24276A, and a compound represented by General Formula (I) described in JP1994-107718A (JP-H06-107718A).

In a case where the ink contains a sensitizer, the content of the sensitizer with respect to the total mass of the ink is preferably 1.0% by mass to 15.0% by mass, more preferably 1.5% by mass to 10.0% by mass, and even more preferably 2.0% by mass to 6.0% by mass.

(Other Components)

The ink according to the present disclosure may further contain the following other components.

The ink according to the present disclosure may contain at least one surfactant. Examples of the surfactant include anionic surfactants such as dialkyl sulfosuccinate, alkylnaphthalene sulfonate, and a fatty acid salt; nonionic surfactants such as polyoxyethylene alkyl ether, polyoxyethylene alkyl allyl ether, acetylene glycol, a polyoxyethylene polyoxypropylene block copolymer, and modified polydimethylsiloxane (for example, BYK-307 manufactured by BYK-Chemie GmbH.); cationic surfactants such as an alkylamine salt and a quatemary ammonium salt, and betaine-based surfactants such as carbobetaine and sulfobetaine. The surfactant may also be a fluorine-based surfactant.

As the surfactant, among these, from the viewpoint of dispersion stability, a nonionic surfactant is preferable, and modified polydimethylsiloxane is more preferable.

In a case where the ink according to the present disclosure contains a surfactant, the content of the surfactant with respect to the total mass of the ink is preferably 0.01% by mass to 5% by mass, more preferably 0.05% by mass to 3% by mass, and even more preferably 0.05% by mass to 1.5% by mass.

The ink according to the present disclosure may contain at least one organic solvent.

Examples of the organic solvent include ketones such as acetone, methyl ethyl ketone, and diethyl ketone; alcohols such as methanol, ethanol, 2-propanol, 1-propanol, 1-butanol, and tert-butanol; chlorine-based solvents such as chloroform and methylene chloride; aromatic solvents such as benzene and toluene; ester-based solvents such as ethyl acetate, butyl acetate, isopropyl acetate, ethyl lactate, butyl lactate, and isopropyl lactate; ether-based solvents such as diethyl ether, tetrahydrofuran, and dioxane; glycol ether-based solvents such as ethylene glycol monomethyl ether, ethylene glycol dimethyl ether, and propylene glycol monomethyl ether; and glycol ether acetate-based solvents such as propylene glycol monomethyl ether acetate.

In a case where the ink according to the present disclosure contains an organic solvent, the content of the organic solvent with respect to the total mass of the ink is preferably 1% by mass or less, more preferably 0.5% by mass or less, and even more preferably 0.1% by mass or less. The ink according to the present disclosure may have a composition that does not contain an organic solvent (that is, the content of the organic solvent may be 0% by mass with respect to the total mass of the ink).

The ink according to the present disclosure may further contain additives such as an ultraviolet absorber, a co-sensitizer, an antioxidant, an antifading agent, and a conductive salt. For the additives, known publications such as JP2011-225848A and JP2009-209352A can be appropriately referred to.

<Physical Properties>

The viscosity of the ink according to the present disclosure is preferably 10 mPa·s to 50 mPa·s, more preferably 10 mPa·s to 30 mPa·s, and even more preferably 10 mPa·s to 25 mPa·s. The viscosity is a value measured at 25° C. using a viscometer. The viscosity is measured, for example, using a VISCOMETER TV-22 type viscometer (manufactured by TOKI SANGYO CO., LTD.).

The surface tension of the ink according to the present disclosure is preferably 20 mN/m to 45 mN/m, and more preferably 23 mN/m to 30 mN/m. The surface tension is a value measured at 25° C. using a surface tensiomter. The surface tension is measured using, for example, DY-700 (manufactured by Kyowa Interface Science Co., Ltd.).

[Image Recording Method]

The image recording method according to the present disclosure includes a step of applying the ink according to the present disclosure to a substrate by an ink jet recording method to record an ink image (hereinafter, also called “ink applying step”) and a step of irradiating the ink image with active energy rays (hereinafter, also called “active energy ray-irradiating step”).

(Ink Applying Step)

In the image recording method of the present disclosure, first, the ink according to the present disclosure is applied to a substrate by an ink jet recording method to record an ink image.

[Substrate]

The substrate is not particularly limited as long as an ink image can be formed thereon. Examples of the substrate include paper, cloth, wood, metals, and plastics.

Examples of the paper include general printing paper mainly composed of cellulose, such as high-quality paper, coated paper, and art paper, and ink jet recording paper. The paper may include an oil-based varnish or a water-based varnish applied thereon.

The substrate may be a permeable substrate or an impermeable substrate. “Impermeable” means that the substrate absorbs little or does not absorb the water contained in the ink, which specifically means the properties in which the amount of water that the substrate absorbs is 10.0 g/m² or less.

In the image recording method according to the present disclosure, particularly in a case where an impermeable substrate is used as a substrate, an image having excellent curing properties can be obtained.

The shape of the impermeable substrate is not particularly limited, and may be a three-dimensional shape such as a bottle, a sheet shape, or a film shape.

Examples of the impermeable substrate include metals (for example, aluminum), plastics (for example, polyvinyl chloride, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinyl acetal), and glass.

It is preferable that the impermeable substrate include a thermoplastic resin such as polyvinyl chloride, polyethylene terephthalate, or polypropylene among the above.

The impermeable substrate may have undergone a surface treatment.

Examples of the surface treatment include a corona treatment, a plasma treatment, a flame treatment, a heat treatment, an abrasion treatment, and a light irradiation treatment (for example, an ultraviolet irradiation treatment).

The corona treatment can be performed using, for example, CORONA MASTER (PS-10S, manufactured by Shinko Electric & Instrumentation Co., Ltd.). The conditions for the corona treatment may be appropriately selected according to the type of the impermeable substrate, the composition of the ink, and the like. The corona treatment can be performed, for example, under the following conditions.

Treatment voltage: 10 to 15.6 kV
Treatment speed: 30 to 100 mm/s

The substrate may also be a transparent substrate or a substrate processed by polyethylene or polypropylene lamination.

Examples of the transparent substrate include glass, quartz, and plastics (for example, cellulose diacetate, cellulose triacetate, cellulose propionate, cellulose butyrate, cellulose acetate butyrate, cellulose nitrate, an acrylic resin, a chlorinated polyolefin resin, a polyether sulfone resin, polyethylene terephthalate (PET), polyethylene naphthalate, nylon, polyethylene, polystyrene, polypropylene, a polycycloolefin resin, a polyimide resin, a polycarbonate resin, polyvinyl acetal, and the like). The transparent substrate may be composed of one layer or two or more layers.

[Ink Jet Recording Method]

The ink jet recording method is not particularly limited as long as it is a method capable of recording an image. The ink jet recording method may be any of known methods, for example, an electric charge control method of jetting an ink by using electrostatic attraction force, a drop-on-demand method using the vibration pressure of a piezo element (pressure pulse method), an acoustic ink jet method of jetting an ink by using radiation pressure by means of converting electric signals into acoustic beams and irradiating the ink with the acoustic beams, and a thermal ink jet (Bubble Jet (registered trademark)) method of forming air bubbles by heating an ink and using the generated pressure.

As the ink jet recording method, particularly, it is possible to effectively use the method described in JP1979-59936A (JP-S54-59936A), which is an ink jet recording method of causing an ink to experience a rapid volume change by the action of heat energy and jetting the ink from a nozzle by using the acting force resulting from the change of state.

Regarding the ink jet recording method, the method described in paragraphs “0093” to “0105” of JP2003-306623A can also be referred to.

Examples of ink jet heads used in the ink jet recording method include ink jet heads for a shuttle method of using short serial heads that are caused to scan a substrate in a width direction of the substrate so as to perform recording and ink jet heads for a line method of using line heads that each consist of recording elements arranged for the entire area of each side of a substrate.

In the line method, by causing the substrate to be scanned in a direction intersecting with the arrangement direction of the recording elements, a pattern can be formed on the entire surface of the substrate. Therefore, this method does not require a transport system such as a carriage that moves short heads for scanning.

Furthermore, in the line method, complicated scanning control for moving a carriage and a substrate is not necessary, and only a substrate moves. Therefore, the recording speed can be further increased in the line method than in the shuttle method.

The amount of ink jetted from the ink jet head is preferably 1 pL (picoliter) to 100 pL, more preferably 3 pL to 80 pL, and even more preferably 3 pL to 20 pL.

In the ink applying step, only one ink may be applied, or two or more inks may be applied. For example, in a case where a color image is to be recorded, it is preferable to apply at least color inks of yellow, cyan, magenta, and black, and it is more preferable to apply color inks of white, yellow, cyan, magenta, and black. Furthermore, the aforementioned color inks may be applied in combination with light color inks such as light magenta and light cyan, a special color ink such as orange, green, and violet, and a clear ink or a metallic ink.

(Active Energy Ray-Irradiating Step)

In the image recording method of the present disclosure, it is preferable to irradiate the ink image with active energy rays. The polymerizable compounds in the ink image are polymerized and cured by the irradiation with active energy rays. Examples of the active energy rays include α-rays, γ-rays, X-rays, ultraviolet rays, visible rays, and electron beams. From the viewpoint of safety and costs, as the active energy rays, among the above, ultraviolet rays (hereinafter, also called “UV”) or visible rays are preferable, and ultraviolet rays are more preferable.

The exposure amount of ultraviolet rays is preferably 20 mJ/cm² to 5 J/cm², and more preferably 100 mJ/cm² to 1,500 mJ/cm². The irradiation time is preferably 0.01 seconds to 120 seconds, and more preferably 0.1 seconds to 90 seconds. As the irradiation conditions and the basic irradiation method, the irradiation conditions and the irradiation method disclosed in JP1985-132767A (JP-S60-132767A) can be adopted. Specifically, it is preferable to use a method of providing a light source on both sides of a head unit including an ink jet device and scanning the substrate by the head unit and the light source by a so-called shuttle method, or a method of irradiating the substrate with another light source that is not involved in driving.

As the light source for ultraviolet irradiation, a mercury lamp, a gas laser, and a solid-state laser are mainly used. A mercury lamp, a metal halide lamp, and an ultraviolet fluorescent lamp are widely known light sources. In addition, using a gallium nitride (GaN)-based semiconductor ultraviolet light emitting device as a substitute is industrially and environmentally extremely useful. Furthermore, a UV light emitting diode (LED) and a UV laser diode (LD) are promising light sources for ultraviolet irradiation because these are compact, have long service life and high efficiency, and inexpensive. As the light source for ultraviolet irradiation, among these, a metal halide lamp, a high-pressure mercury lamp, a medium-pressure mercury lamp, a low-pressure mercury lamp, or UV-LED is preferable.

Examples of UV-LED include a purple LED (manufactured by NICHIA CORPORATION) having a main emission spectrum at a wavelength between 365 nm and 420 nm. U.S. Pat. No. 6,084,250B discloses, as LED having a shorter wavelength, LED that can emit ultraviolet rays having a wavelength between 300 nm and 370 nm. Furthermore, combining several UV-LEDs makes it possible to radiate ultraviolet rays in different wavelength ranges. The peak wavelength of the ultraviolet rays is, for example, preferably 200 nm to 405 nm, more preferably 220 nm to 400 nm, and even more preferably 340 nm to 400 nm.

In a case where active energy ray irradiation is performed in an atmosphere with an oxygen concentration of 1% by volume or less after the ink applying step, it is possible to inhibit oxygen from hindering polymerization and to improve curing properties. The lower limit of the oxygen concentration is not particularly limited. By making a vacuum state or substituting the irradiation atmosphere with a gas (for example, nitrogen) other than the air, it is possible to make the oxygen concentration substantially zero. The oxygen concentration in the active energy ray-irradiating step is preferably 0.01% by volume to 1% by volume, and more preferably 0.10% by volume to 1% by volume.

Examples of means for controlling the oxygen concentration of the irradiation atmosphere include a method of making the ink jet recording device a closed system and creating a nitrogen atmosphere or a carbon dioxide atmosphere, and a method of letting an inert gas such as nitrogen to flow. Examples of nitrogen supplying methods include a method of using a nitrogen gas cylinder, and a method of using a device separating only a nitrogen gas from the air by exploiting the difference between permeability of oxygen to a hollow membrane and permeability of nitrogen to a hollow membrane. Examples of carbon dioxide supplying methods include a method of using a carbon dioxide gas cylinder. The inert gas refers to a general gas such as N₂, H₂, or CO₂, and a rare gas such as He, Ne, or Ar. From the viewpoint of safety, ease of availability, and costs, among the above, N₂ is preferable as the inert gas.

(Other Steps)

The image recording method according to the present disclosure may include other steps in addition to the ink applying step and the active energy ray-irradiating step. Examples of those other steps include a drying step of drying the ink image after the ink applying step. The drying means and the drying temperature in the drying step can be appropriately adjusted.

### EXAMPLE

Hereinafter, examples of the present disclosure will be described, but the present disclosure is not limited to the following examples.

Details of each component contained in the inks of examples and comparative examples are as follows.

<Pigment>

Compound B-1: Squarylium dye
Compound B-3: Squarylium dye
Compound B-39: Squarylium dye
Compound B-27: Squarylium dye
Compound P-1: Pyrrolopyrrole boron dye

The structural formula of each pigment is as follows. In the formula, “Ph” represents a phenyl group.

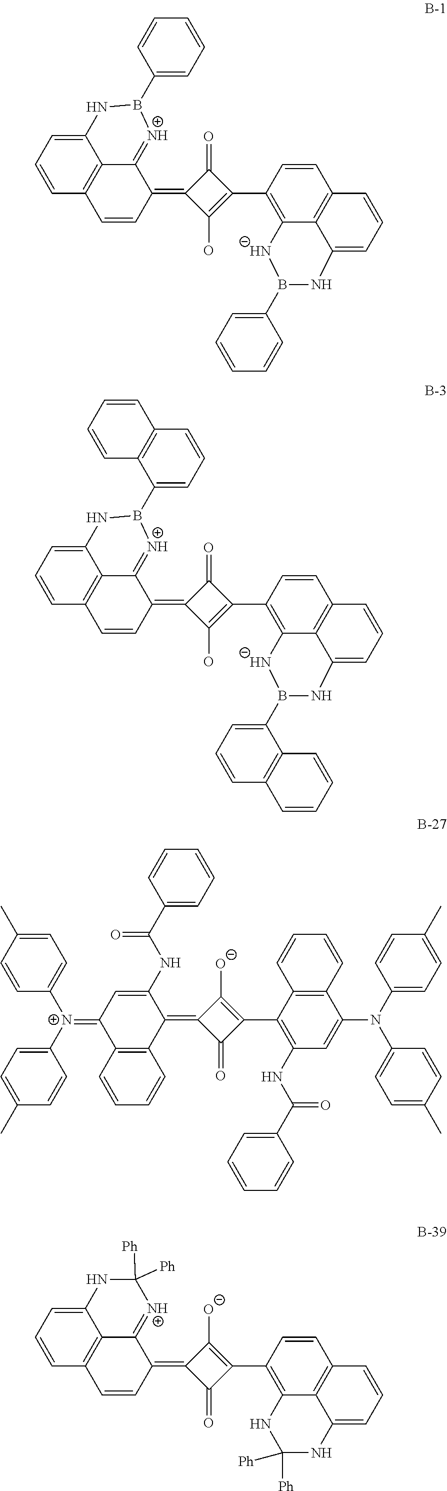 [SMILES: O=C1C(c2ccc3cccc4c3c2[N-]B(c2ccccc2)N4)=C(O)/C1=c1\ccc2cccc3c2c1=[NH+]B(c1ccccc1)N3 ; O=C1C(c2ccc3cccc4c3c2[N-]B(c2cccc3ccccc23)N4)=C(O)/C1=c1\ccc2cccc3c2c1=[NH+]B(c1cccc2ccccc12)N3 ; Cc1ccc(N(c2ccc(C)cc2)c2cc(NC(=O)c3ccccc3)c(C3=C([O-])/C(=C4\C(NC(=O)c5ccccc5)=CC(=[N+](c5ccc(C)cc5)c5ccc(C)cc5)c5ccccc54)C3=O)c3ccccc23)cc1 ; O=C1C(c2ccc3cccc4c3c2NC(c2ccccc2)(c2ccccc2)N4)=C([O-])/C1=c1/ccc2cccc3c2c1=[NH+]C(c1ccccc1)(c1ccccc1)N3]

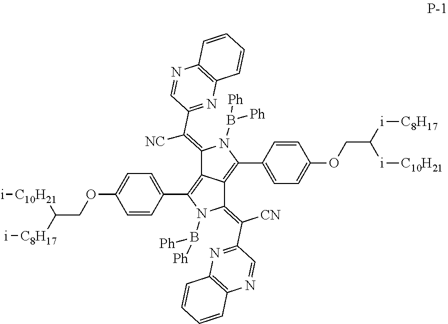

<Synergist>
EFKA 6745 (manufactured by BASF SE): Copper phthalocyanine having sulfo group
SOLSPERSE 5000S (manufactured by lubrizol Japan Limited): copper phthalocyanine having sulfo group
2,6-Naphthalene dicarboxylic acid (manufactured by Tokyo Chemical Industry Co., Ltd.)
NEWKALGEN PS-P (manufactured by tAKEMOTO OIL & FAT Co., Ltd.): Sodium salt of naphthalene sulfonate formaldehyde condensate
Direct 106 (manufactured by Tokyo Chemical Industry Co., Ltd.): Dioxazine-based colorant derivative having sulfo group
Compound S-1: Anthraquinone-based colorant derivative having sulfo group
Compound S-2: Diketopyrrolopyrrole-based colorant derivative having sulfo group
Compound S-3: Azo-based colorant derivative having no sulfo group

The structural formula of each synergist is as follows.

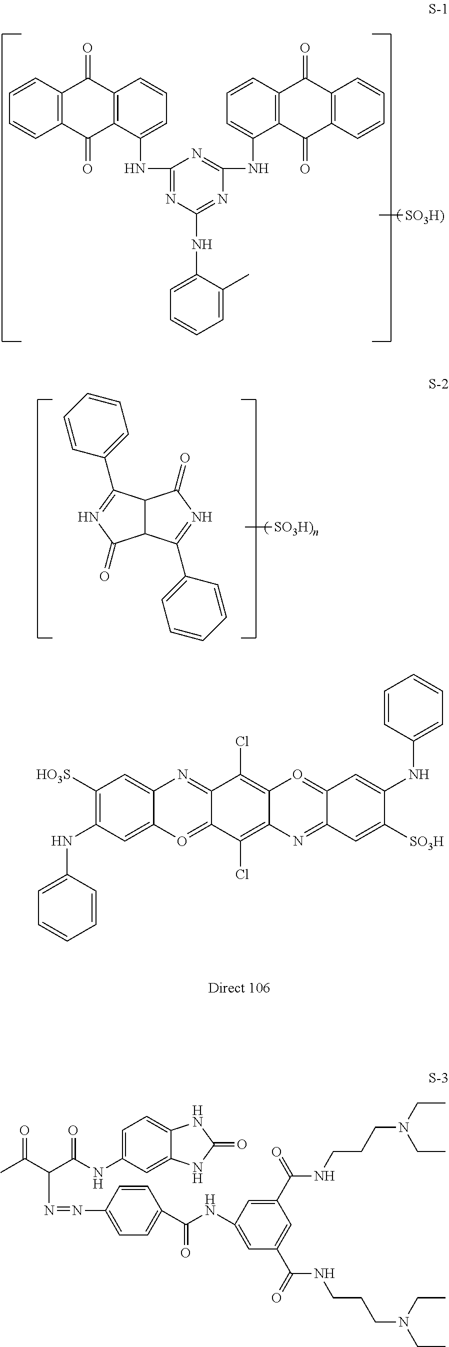

<Polymerizable Compound>
SR341 (manufactured by Sartomer): 3-Methyl-1,5-pentanediol diacrylate, SP value 17.6 MPa^{1/2}
CTFA: Cyclic trimethylolpropane formal acrylate, SP value 18.9 MPa^{1/2}
NVC: N-vinylcaprolactam, SP value 20.0 MPa^{1/2}
SR344 (manufactured by Sartomer): Polyethylene glycol (400) diacrylate, SP value 18.6 MPa^{1/2}

<Dispersant>
EFKA PX 4701 (manufactured by BASF SE): Block copolymer, base number 40 mgKOH/g
SOLSPERSE 71000 (manufactured by Lubrizol Japan Limited): Graft polymer with polyethyleneimine as main chain, base number 77 mgKOH/g
SOLSPERSE 35000 (manufactured by Lubrizol Japan Limited): Graft polymer with polyethyleneimine as main chain, base number 15 mgKOH/g
DISPER BYK 167 (manufactured by BYK-Chemie GmbH.): Polymer having structure derived from toluene diisocyanate, valerolactone, and decanol, base number 13 mgKOH/g

<Polymerization Initiator>
Omnirad 819 (manufactured by IGM Resins B.V.): Bis(2,4,6-trimethylbenzoyl)phenylphosphine oxide
Omnirad TPO H (manufactured by IGM Resins B.V.): 2,4,6-Trimethylbenzoyldiphenylphosphine oxide
Omnirad TPO-L (manufactured by IGM Resins B.V.): (2,4,6-Trimethylbenzoyl)ethoxyphenylphosphine oxide
Speedcure7010L: Mixture of 1,3-di({α-[1-chloro-9-oxo-9H-thioxanthen-4-yl)oxy]acetylpoly[oxy(1-methylethylene)]}oxy)-2,2-bis({α-[1-methylethylene)]}oxymethyl)propane and trimethylolpropane EO-added triacrylate (mixing ratio (based on mass) 1:1)

<Surfactant>
BYK-307 (manufactured by BYK-Chemie GmbH.): modified polydimethylsiloxane

<Polymerization Inhibitor>
FLORSTAB UV12 (manufactured by Kromachem Ltd): N-nitroso-N-phenylhydroxylamine aluminum salt
TEMPOL: 2,2,6,6-Tetramethyl-4-hydroxypiperidine-1-oxyl
MEHQ: p-Methoxyphenol

In the table, FLORSTAB UV12 is abbreviated to “UV12”.

### Example 10

The components were mixed together to obtain the following composition, and subjected to pre-dispersion for 30 minutes using a stirrer. Then, a dispersion treatment using a batch-type beads mill (trade name “EASY NANO RMB”, manufactured by AIMEX CO., Ltd.) and zirconia beads having a diameter of 0.5 mmφ was performed on the mixture at 1,000 rpm (rotation speed/min) until the target particle size was obtained. The mixture was filtered using a 67 μm filter cloth and a 5 μm filter, thereby obtaining a dispersion A1.

<Composition>

| | | |
|---|---|---|
| Compound B-1 | 2% | by mass |
| EFKA 6745 | 0.01% | by mass |
| SR341 | 95.99% | by mass |
| EFKA PX 4701 | 2% | by mass |

Next, the components were mixed together to obtain the following composition, thereby preparing an ink.

<Composition>

| | | |
|---|---|---|
| The above dispersion A1 | 50% | by mass |
| SR341 | 6.1% | by mass |
| NVC | 30% | by mass |
| Omnirad 819 | 4% | by mass |
| Omnirad TPO H | 4% | by mass |
| Speedcure 7010L | 4% | by mass |
| FLORSTAB UV12 | 1% | by mass |
| TEMPOL | 0.3% | by mass |
| MEHQ | 0.5% | by mass |
| BYK-307 | 0.1% | by mass |

### Examples 1 to 9, Examples 11 to 63, and Comparative Examples 1 to 3

Dispersions and inks were prepared by the same method as the method in Example 10, except that in Example 10, the content of each of the components contained in each ink was changed to the content (% by mass) described in Tables 1 to 8.

<Image Recording>

The ink cartridge attached to an ink jet recording device (trade name “DMP-2850”, manufactured by FUJIFILM Corporation) was filled with each of the inks prepared in examples and comparative examples, and a 100% halftone dot image was recorded on a substrate under the conditions of 600 dpi (dots per inch) and a jetting amount of 10 pL. As the substrate, a polyethylene terephthalate (PET) film and coated paper (OK TOPCOAT, manufactured by Oji Paper Co., Ltd.) were used. Then, the image was irradiated with ultraviolet rays, thereby obtaining an article with a recorded image.

By using each of the inks prepared in examples and comparative examples, dispersibility, temporal stability, curing properties, and light resistance were evaluated. The evaluation results are shown in Tables 1 to 8.

[Dispersibility]

Immediately after the inks were prepared, the particle size of the pigment contained in each ink was measured using a particle size measuring device (trade name “Zetasizer Nano ZS”, manufactured by Malvern Panalytical Ltd). It can be said that the smaller the particle size, the better the dispersibility. The evaluation standard is as follows.

A: The particle size is less than 300 nm.

B: The particle size is 300 nm or more and less than 450 nm.

C: The particle size is 450 nm or more.

[Temporal stability]

After the inks were prepared, the airtight container containing each ink was left to stand at 40° C. for 1 week. After 1 week, the particle size of the pigment contained in each ink was measured using a particle size measuring device (trade name “Zetasizer Nano ZS”, manufactured by Malvern Panalytical Ltd). It can be said that the smaller the particle size, the better the temporal stability. The evaluation standard is as follows.

A: The particle size is less than 300 nm.

B: The particle size is 300 nm or more and less than 450 nm.

C: The particle size is 450 nm or more.

[Curing Properties]

The ink cartridge attached to an ink jet recording device (trade name “DMP-2850”, manufactured by FUJIFILM Corporation) was filled with each ink, and a 100% halftone dot image was recorded on a PET film under the conditions of 600 dpi and a jetting amount of 10 pL.

As an exposure condition 1, while being recorded, the image was exposed at about 250 mW/cm² by using a 395 nm LED lamp (trade name “PEL UV CURE UNIT”, manufactured by PRINTED ELECTRONICS LTD).

As an exposure condition 2, the image was exposed not in process of image recording but after image recording, by using a metal halide lamp (trade name “CSOT-40”, manufactured by GS Yuasa International Ltd.) at an output of 100 W and a speed of 10 m/min.

As an exposure condition 3, the image was exposed not in the process of image recording but after image recording, by using an LED light source having a wavelength of 385 nm in a nitrogen atmosphere (oxygen concentration of 1% or less) at 4,000 mW/cm².

Each of the article with a recorded image obtained after the exposure under the exposure condition 1, the article with a recorded image obtained after the exposure under the exposure condition 2, and the article with a recorded image obtained after the exposure under the exposure condition 3 was rubbed with a cotton swab, and whether or not the ink was attached to the cotton swab was visually observed. In a case where no ink was attached to the cotton swab, it was determined that the ink was cured. In a case where the ink was attached to the cotton swab, it was determined that the ink was not cured. The evaluation standard is as follows.

A: The ink was cured under all of the exposure condition 1, the exposure condition 2, and the exposure condition 3.

B: The ink was cured only under the exposure condition 2 and the exposure condition 3.

C: The ink was cured only under the exposure condition 3.

D: The ink was not cured under any exposure conditions.

[Light Resistance]

The ink cartridge attached to an ink jet recording device (trade name “DMP-2850”, manufactured by FUJIFILM Corporation) was filled with each ink, and a 100% halftone dot image was recorded on coated paper (OK TOPCOAT, manufactured by Oji Paper Co., Ltd.) under the conditions of 600 dpi and a jetting amount of 10 pL. After being recorded, the image was exposed using a metal halide lamp (trade name “CSOT-40”, manufactured by GS Yuasa International Ltd.) at an output of 100 W and a speed of 10 m/min. By using the obtained article with a recorded image, a light resistance test was performed. The light resistance was evaluated based on the amount of change in reflectivity. The amount of change in reflectivity was calculated based on the following formula.

Amount of change in reflectivity=(reflectivity that article with recorded image has at 850 nm after going through exposure once)−(reflectivity that article with recorded image has at 850 nm after going through exposure 4 times)

The reflectivity was measured using an ultraviolet-visible-near infrared spectrophotometer (trade name “V-570”, manufactured by JASCO Corporation).

It can be said that the smaller the amount of change in reflectivity, the better the light resistance. The evaluation standard is as follows.

A: The amount of change in reflectivity is less than 10%.

B: The amount of change in reflectivity is 10% or more and less than 25%.

C: The amount of change in reflectivity is 25% or more.

In Tables 1 to 8, “Dispersant/pigment” means the ratio (mass ratio) of the content of the dispersant to the content of the pigment. “Synergist/pigment×100” means the content (% by mass) of the synergist with respect to the total mass of the pigment.

TABLE 1

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Pigment | Compound B-1 | 1 | 1 | 1 | 1 | 1 | 1 | 1 | 2 |
| Synergist | EFKA 6745 | 0.005 | — | — | 0.005 | 0.005 | 0.005 | 0.005 | 0.005 |
| | 2,6-Naphthalenedicarboxylic | — | 0.005 | — | — | — | — | — | — |
| | acid | | | | | | | | |
| | Newkalgen PS-P | — | — | 0.005 | — | — | — | — | — |
| Polymerizable | SR341 | 89.095 | 89.095 | 89.095 | 89.095 | 84.095 | 39.095 | 59.095 | 58.095 |
| compound | (SP value 17.6 MPa^{1/2}) | | | | | | | | |
| | NVC | — | — | — | — | 5 | 50 | 30 | 30 |
| | (SP value 20.0 MPa^{1/2}) | | | | | | | | |
| Dispersant | EFKA PX 4701 | — | 1 | 1 | 1 | 1 | 1 | 1 | 1 |
| | (base number 40 mgKOH/g) | | | | | | | | |
| | DISPER BYK 167 | 1 | — | — | — | — | — | — | — |
| | (base number 13 mgKOH/g) | | | | | | | | |
| Polymerization | Omnirad 819 | 4 | 4 | 4 | 4 | 4 | 4 | 4 | 4 |
| initiator | Omnirad TPO H | 2 | 2 | 2 | 2 | 2 | 2 | 2 | 2 |
| | Speedcure 7010L | 2 | 2 | 2 | 2 | 2 | 2 | 2 | 2 |
| Surfactant | BYK307 | 0.1 | 0.1 | 0.1 | 0.1 | 0.1 | 0.1 | 0.1 | 0.1 |
| Polymerization | UV12 | 0 | 0 | 0 | 0 | 0 | 0 | 0 | 0.3 |
| inhibitor | TEMPOL | 0.3 | 0.3 | 0.3 | 0.3 | 0.3 | 0.3 | 0.3 | 0 |
| | MEHQ | 0.5 | 0.5 | 0.5 | 0.5 | 0.5 | 0.5 | 0.5 | 0.5 |
| Dispersant/pigment | | 1 | 1 | 1 | 1 | 1 | 1 | 1 | 0.5 |
| Synergist/pigment × 100 | | 0.5 | 0.5 | 0.5 | 0.5 | 0.5 | 0.5 | 0.5 | 0.25 |
| Evaluation | Dispersibility | B | B | B | A | A | A | A | A |
| | Temporal stability | B | B | B | B | B | C | B | B |
| | Curing properties | D | D | D | D | C | B | B | B |
| | Light resistance | A | A | A | A | A | A | A | A |

| | | Exam- | Exam- | Exam- | Exam- | Exam- |
|---|---|---|---|---|---|---|
| | | ple 9 | ple 10 | ple 11 | ple 12 | ple 13 |
| Pigment | Compound B-1 | 3 | 1 | 1 | 1 | 1 |
| Synergist | EFKA 6745 | 0.005 | 0.005 | 0.005 | 0.005 | 0.005 |
| | 2,6-Naphthalenedicarboxylic | — | — | — | — | — |
| | acid | | | | | |
| | Newkalgen PS-P | — | — | — | — | — |
| Polymerizable | SR341 | 57.095 | 58.095 | 58.095 | 58.095 | 54.095 |
| compound | (SP value 17.6 MPa^{1/2}) | | | | | |
| | NVC | 30 | 30 | 30 | 30 | 30 |
| | (SP value 20.0 MPa^{1/2}) | | | | | |
| Dispersant | EFKA PX 4701 | 1 | 1 | 1 | 1 | 1 |
| | (base number 40 mgKOH/g) | | | | | |
| | DISPER BYK 167 | — | — | — | — | — |
| | (base number 13 mgKOH/g) | | | | | |
| Polymerization | Omnirad 819 | 4 | 4 | 2 | 2 | 4 |
| initiator | Omnirad TPO H | 2 | 2 | 4 | 2 | 4 |
| | Speedcure 7010L | 2 | 2 | 2 | 4 | 4 |
| Surfactant | BYK307 | 0.1 | 0.1 | 0.1 | 0.1 | 0.1 |
| Polymerization | UV12 | 0.3 | 1 | 1 | 1 | 1 |
| inhibitor | TEMPOL | 0.5 | 0.3 | 0.3 | 0.3 | 0.3 |
| | MEHQ | 0 | 0.5 | 0.5 | 0.5 | 0.5 |
| Dispersant/pigment | | 0.33 | 1 | 1 | 1 | 1 |
| Synergist/pigment × 100 | | 0.17 | 0.5 | 0.5 | 0.5 | 0.5 |
| Evaluation | Dispersibility | A | A | A | A | A |
| | Temporal stability | B | A | A | A | A |
| | Curing properties | B | B | B | B | A |
| | Light resistance | A | A | A | A | A |

TABLE 2

| | | Exam- | Exam- | Exam- | Exam- | Exam- | Exam- | Exam- | Exam- | Exam- | Exam- |
|---|---|---|---|---|---|---|---|---|---|---|---|
| | | ple 14 | ple 15 | ple 16 | ple 17 | ple 18 | ple 19 | ple 20 | ple 21 | ple 22 | ple 23 |
| Pigment | Compound B-1 | 1 | 1 | 1 | 1 | 2 | 3 | 1 | 1 | 1 | 1 |
| Synergist | EFKA 6745 | 0.001 | 0.02 | 0.1 | 0.2 | 0.005 | 0.005 | 0.005 | 0.005 | 0.005 | 0.005 |
| Polymerizable | SR341 | 54.099 | 54.080 | 54.000 | 53.900 | 53.095 | 52.095 | 54.695 | 53.095 | 52.095 | 45.095 |
| compound | (SP value 17.6 MPa^{1/2}) | | | | | | | | | | |
| | NVC | 30 | 30 | 30 | 30 | 30 | 30 | 30 | 30 | 30 | 30 |
| | (SP value 20.0 MPa^{1/2}) | | | | | | | | | | |
| Dispersant | EFKA PX 4701 | 1 | 1 | 1 | 1 | 1 | 1 | 0.4 | 2 | 3 | 10 |
| | (base number 40 | | | | | | | | | | |
| | mgKOH/g) | | | | | | | | | | |
| Polymerization | Omnirad 819 | 4 | 4 | 4 | 4 | 4 | 4 | 4 | 4 | 4 | 4 |
| initiator | Omnirad TPO H | 4 | 4 | 4 | 4 | 4 | 4 | 4 | 4 | 4 | 4 |
| | Speedcure 7010L | 4 | 4 | 4 | 4 | 4 | 4 | 4 | 4 | 4 | 4 |
| Surfactant | BYK307 | 0.1 | 0.1 | 0.1 | 0.1 | 0.1 | 0.1 | 0.1 | 0.1 | 0.1 | 0.1 |
| Polymerization | UV12 | 1 | 1 | 1 | 1 | 1 | 1 | 1 | 1 | 1 | 1 |
| inhibitor | TEMPOL | 0.3 | 0.3 | 0.3 | 0.3 | 0.3 | 0.3 | 0.3 | 0.3 | 0.3 | 0.3 |
| | MEHQ | 0.5 | 0.5 | 0.5 | 0.5 | 0.5 | 0.5 | 0.5 | 0.5 | 0.5 | 0.5 |
| Dispersant/pigment | | 1 | 1 | 1 | 1 | 0.5 | 0.33 | 0.4 | 2 | 3 | 10 |
| Synergist/pigment × 100 | | 0.1 | 2 | 10 | 20 | 0.25 | 0.17 | 0.5 | 0.5 | 0.5 | 0.5 |
| Evaluation | Dispersibility | A | A | A | B | A | A | B | A | A | B |
| | Temporal stability | B | A | A | A | A | A | B | A | A | B |
| | Curing properties | A | A | A | A | A | A | A | A | A | A |
| | Light resistance | A | A | A | A | A | A | A | A | A | A |

TABLE 3

| | | Exam- | Exam- | Exam- | Exam- | Exam- | Exam- | Exam- | Exam- | Exam- | Exam- |
|---|---|---|---|---|---|---|---|---|---|---|---|
| | | ple 24 | ple 25 | ple 26 | ple 27 | ple 28 | ple 29 | ple 30 | ple 31 | ple 32 | ple 33 |
| Pigment | Compound B-1 | 1 | 1 | 1 | 1 | — | — | — | 1 | 1 | 1 |
| | Compound B-3 | — | — | — | — | 1 | — | — | — | — | — |
| | Compound B-39 | — | — | — | — | — | 1 | — | — | — | — |
| | Compound B-27 | — | — | — | — | — | — | 1 | — | — | — |
| Synergist | EFKA 6745 | — | — | — | — | 0.005 | 0.005 | 0.005 | 0.005 | 0.005 | 0.005 |
| | SOLSPERSE 5000S | 0.005 | — | — | — | — | — | — | — | — | — |
| | Compound S-1 | — | 0.005 | — | — | — | — | — | — | — | — |
| | Compound S-2 | — | — | 0.005 | — | — | — | — | — | — | — |
| | Direct 106 | — | — | — | 0.005 | — | — | — | — | — | — |
| Polymerizable | SR341 | 54.095 | 54.095 | 54.095 | 54.095 | 54.095 | 54.095 | 54.095 | 54.095 | 54.095 | 89.095 |
| compound | (SP value 17.6 MPa^{1/2}) | | | | | | | | | | |
| | NVC | 30 | 30 | 30 | 30 | 30 | 30 | 30 | 30 | 30 | — |
| | (SP value 20.0 MPa^{1/2}) | | | | | | | | | | |
| Dispersant | EFKA PX 4701 | 1 | 1 | 1 | 1 | 1 | 1 | 1 | — | — | — |
| | (base number 40 mgKOH/g) | | | | | | | | | | |
| | SOLSPERSE 71000 | — | — | — | — | — | — | — | 1 | — | — |
| | (base number 77 mgKOH/g) | | | | | | | | | | |
| | SOLSPERSE 35000 | — | — | — | — | — | — | — | — | 1 | 1 |
| | (base number 15 mgKOH/g) | | | | | | | | | | |
| Polymerization | Omnirad 819 | 4 | 4 | 4 | 4 | 4 | 4 | 4 | 4 | 4 | 4 |
| initiator | Omnirad TPO H | 4 | 4 | 4 | 4 | 4 | 4 | 4 | 4 | 4 | 2 |
| | Speedcure 7010L | 4 | 4 | 4 | 4 | 4 | 4 | 4 | 4 | 4 | 2 |
| Surfactant | BYK307 | 0.1 | 0.1 | 0.1 | 0.1 | 0.1 | 0.1 | 0.1 | 0.1 | 0.1 | 0.1 |
| Polymerization | UV12 | 1 | 1 | 1 | 1 | 1 | 1 | 1 | 1 | 1 | 0 |
| inhibitor | TEMPOL | 0.3 | 0.3 | 0.3 | 0.3 | 0.3 | 0.3 | 0.3 | 0.3 | 0.3 | 0.3 |
| | MEHQ | 0.5 | 0.5 | 0.5 | 0.5 | 0.5 | 0.5 | 0.5 | 0.5 | 0.5 | 0.5 |
| Dispersant/pigment | | 1 | 1 | 1 | 1 | 1 | 1 | 1 | 1 | 1 | 1 |
| Synergist/pigment × 100 | | 0.5 | 0.5 | 0.5 | 0.5 | 0.5 | 0.5 | 0.5 | 0.5 | 0.5 | 0.5 |
| Evaluation | Dispersibility | A | A | A | A | A | A | A | A | A | A |
| | Temporal stability | A | A | A | A | A | B | B | A | A | B |
| | Curing properties | A | A | A | A | A | A | A | A | A | D |
| | Light resistance | A | A | A | A | A | A | B | A | A | A |

TABLE 4

| | | Example 34 | Example 35 | Example 36 | Example 37 |
|---|---|---|---|---|---|
| Pigment | Compound B-1 | 5 | 5 | 0.5 | 0.5 |
| Synergist | EFKA 6745 | 0.005 | 0.025 | 0.1 | 0.075 |
| Polymerizable | SR341 | 46.095 | 46.075 | 55.000 | 55.025 |
| compound | (SP value 17.6 MPa^{1/2}) | | | | |
| | NVC | 30 | 30 | 30 | 30 |
| | (SP value 20.0 MPa^{1/2}) | | | | |
| Dispersant | EFKA PX 4701 | 5 | 5 | 0.5 | 0.5 |
| | (base number 40 mgKOH/g) | | | | |
| Polymerization | Omnirad 819 | 4 | 4 | 4 | 4 |
| initiator | Omnirad TPO H | 4 | 4 | 4 | 4 |
| | Speedcure 7010L | 4 | 4 | 4 | 4 |
| Surfactant | BYK307 | 0.1 | 0.1 | 0.1 | 0.1 |
| Polymerization | UV12 | 1 | 1 | 1 | 1 |
| inhibitor | TEMPOL | 0.3 | 0.3 | 0.3 | 0.3 |
| | MEHQ | 0.5 | 0.5 | 0.5 | 0.5 |
| Dispersant/pigment | | 1 | 1 | 1 | 1 |
| Synergist/pigment × 100 | | 0.1 | 0.5 | 20 | 15 |
| Evaluation | Dispersibility | B | A | B | A |
| | Temporal stability | A | A | A | A |
| | Curing properties | A | A | A | A |
| | Light resistance | A | A | A | A |

TABLE 5

| | | Exam- | Exam- | Exam- | Exam- | Exam- | Exam- | Exam- | Exam- | Exam- |
|---|---|---|---|---|---|---|---|---|---|---|
| | | ple 38 | ple 39 | ple 40 | ple 41 | ple 42 | ple 43 | ple 44 | ple 45 | ple 46 |
| Pigment | Compound B-1 | 1 | 1 | 1 | 1 | 1 | 1 | 1 | 1 | 1 |
| Synergist | EFKA 6745 | — | 0.005 | 0.005 | 0.005 | 0.005 | 0.005 | 0.005 | 0.005 | 0.005 |
| | Direct 106 | 0.005 | — | — | — | — | — | — | — | — |
| Polymerizable | SR341 | 89.095 | 89.095 | 89.095 | 89.095 | 89.095 | 85.095 | 79.095 | 78.095 | 53.095 |
| compound | (SP value 17.6 MPa^{1/2}) | | | | | | | | | |
| | NVC | — | — | — | — | — | — | — | — | 25.00 |
| | (SP value 20.0 MPa^{1/2}) | | | | | | | | | |
| Dispersant | EFKA PX 4701 | — | — | 1 | 1 | 1 | 1 | 1 | 1 | 1 |
| | (base number 40 mgKOH/g) | | | | | | | | | |
| | DISPER BYK 167 | 1 | 1 | — | — | — | — | — | — | — |
| | (base number 13 mgKOH/g) | | | | | | | | | |
| Polymerization | Omnirad 819 | 4 | 4 | 4 | 2 | 2 | 4 | 4 | 4 | 4 |
| initiator | Omnirad TPO-L | 2 | 2 | 2 | 4 | 2 | 4 | 4 | 4 | 4 |
| | Speedcure 7010L | 2 | 2 | 2 | 2 | 4 | 4 | 10 | 10 | 10 |
| Surfactant | BYK307 | 0.1 | 0.1 | 0.1 | 0.1 | 0.1 | 0.1 | 0.1 | 0.1 | 0.1 |
| Polymerization | UV12 | 0 | 0 | 0 | 0 | 0 | 0 | 0 | 1 | 1 |
| inhibitor | TEMPOL | 0.3 | 0.3 | 0.3 | 0.3 | 0.3 | 0.3 | 0.3 | 0.3 | 0.3 |
| | MEHQ | 0.5 | 0.5 | 0.5 | 0.5 | 0.5 | 0.5 | 0.5 | 0.5 | 0.5 |
| Dispersant/pigment | | 1 | 1 | 1 | 1 | 1 | 1 | 1 | 1 | 1 |
| Synergist/pigment × 100 | | 0.5 | 0.5 | 0.5 | 0.5 | 0.5 | 0.5 | 0.5 | 0.5 | 0.5 |
| Evaluation | Dispersibility | B | B | A | A | A | A | A | A | A |
| | Temporal stability | C | B | B | B | B | B | B | A | A |
| | Curing properties | D | D | D | D | D | C | B | B | A |
| | Light resistance | A | A | A | A | A | A | A | A | A |

TABLE 6

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple 47 | ple 48 | ple 49 | ple 50 | ple 51 | ple 52 | ple 53 | ple 54 | ple 55 | ple 56 | ple 57 |
| Pigment | Compound B-1 | 1 | 1 | 1 | 1 | 0.05 | 2 | 3 | 1 | 1 | 1 | 1 |
| Synergist | EFKA 6745 | 0.001 | 0.02 | 0.1 | 0.2 | 0.005 | 0.005 | 0.005 | 0.005 | 0.005 | 0.005 | 0.005 |
| Polymerizable | SR341 | 53.099 | 53.080 | 53.000 | 52.900 | 54.045 | 52.095 | 51.095 | 53.695 | 52.095 | 51.095 | 44.095 |
| compound | (SP value 17.6 | | | | | | | | | | | |
| | MPa^{1/2}) | | | | | | | | | | | |
| | CFTA | 25.00 | 25.00 | 25.00 | 25.00 | 25.00 | 25.00 | 25.00 | 25.00 | 25.00 | 25.00 | 25.00 |
| | (SP value 18.9 | | | | | | | | | | | |
| | MPa^{1/2}) | | | | | | | | | | | |
| Dispersant | EFKA PX 4701 | 1 | 1 | 1 | 1 | 1 | 1 | 1 | 0.4 | 2 | 3 | 10 |
| | (base number 40 | | | | | | | | | | | |
| | mgKOH/g) | | | | | | | | | | | |
| Polymerization | Omnirad 819 | 4 | 4 | 4 | 4 | 4 | 4 | 4 | 4 | 4 | 4 | 4 |
| initiator | Omnirad TPO-L | 4 | 4 | 4 | 4 | 4 | 4 | 4 | 4 | 4 | 4 | 4 |
| | Speedcure 7010L | 10 | 10 | 10 | 10 | 10 | 10 | 10 | 10 | 10 | 10 | 10 |
| Surfactant | BYK307 | 0.1 | 0.1 | 0.1 | 0.1 | 0.1 | 0.1 | 0.1 | 0.1 | 0.1 | 0.1 | 0.1 |
| Polymerization | UV12 | 1 | 1 | 1 | 1 | 1 | 1 | 1 | 1 | 1 | 1 | 1 |
| inhibitor | TEMPOL | 0.3 | 0.3 | 0.3 | 0.3 | 0.3 | 0.3 | 0.3 | 0.3 | 0.3 | 0.3 | 0.3 |
| | MEHQ | 0.5 | 0.5 | 0.5 | 0.5 | 0.5 | 0.5 | 0.5 | 0.5 | 0.5 | 0.5 | 0.5 |
| Dispersant/pigment | | 1 | 1 | 1 | 1 | 20 | 0.5 | 0.33 | 0.4 | 2 | 3 | 10 |
| Synergist/pigment × 100 | | 0.1 | 2 | 10 | 20 | 10 | 0.25 | 0.17 | 0.5 | 0.5 | 0.5 | 0.5 |
| Evaluation | Dispersibility | A | A | A | B | A | A | A | B | A | A | B |
| | Temporal stability | B | A | A | A | B | A | A | B | A | A | B |
| | Curing properties | A | A | A | A | A | A | A | A | A | A | A |
| | Light resistance | A | A | A | A | A | A | A | A | A | A | A |

TABLE 7

| | | Example | Example | Example | Example | Example | Example |
|---|---|---|---|---|---|---|---|
| | | 58 | 59 | 60 | 61 | 62 | 63 |
| Pigment | Compound B-1 | 1 | 1 | — | — | — | 1 |
| | Compound B-3 | — | — | 1 | — | — | — |
| | Compound B-39 | — | — | — | 1 | — | — |
| | Compound B-27 | — | — | — | — | 1 | — |
| Synergist | EFKA 6745 | — | — | 0.005 | 0.005 | 0.005 | 0.005 |
| | Compound S-1 | 0.005 | — | — | — | — | — |
| | Direct 106 | — | 0.005 | — | — | — | — |
| Polymerizable | SR341 | 53.095 | 53.095 | 53.095 | 53.095 | 53.095 | 53.095 |
| compound | (SP value 17.6 | | | | | | |
| | MPa^{1/2}) | | | | | | |
| | CTFA | 25.00 | — | — | 25.00 | 25.00 | — |
| | (SP value 18.9 | | | | | | |
| | MPa^{1/2}) | | | | | | |
| | NVC | — | 25.00 | — | — | — | 25.00 |
| | (SP value 20.0 | | | | | | |
| | MPa^{1/2}) | | | | | | |
| | SR344 | — | — | 25.00 | — | — | — |
| | (SP value 18.6 | | | | | | |
| | MPa^{1/2}) | | | | | | |
| Dispersant | EFKA PX 4701 | 1 | 1 | 1 | 1 | 1 | — |
| | (base number 40 | | | | | | |
| | mgKOH/g) | | | | | | |
| | SOLSPERSE 35000 | — | — | — | — | — | 1 |
| | (base number 15 | | | | | | |
| | mgKOH/g) | | | | | | |
| Polymerization | Omnirad 819 | 4 | 4 | 4 | 4 | 4 | 4 |
| initiator | Omnirad TPO-L | 4 | 4 | 4 | 4 | 4 | 4 |
| | Speedcure 7010L | 10 | 10 | 10 | 10 | 10 | 10 |
| Surfactant | BYK307 | 0.1 | 0.1 | 0.1 | 0.1 | 0.1 | 0.1 |
| Polymerization | UV12 | 1 | 1 | 1 | 1 | 1 | 1 |
| inhibitor | TEMPOL | 0.3 | 0.3 | 0.3 | 0.3 | 0.3 | 0.3 |
| | MEHQ | 0.5 | 0.5 | 0.5 | 0.5 | 0.5 | 0.5 |
| Dispersant/pigment | | 1 | 1 | 1 | 1 | 1 | 1 |
| Synergist/pigment × 100 | | 0.5 | 0.5 | 0.5 | 0.5 | 0.5 | 0.5 |
| Evaluation | Dispersibility | A | A | A | A | A | A |
| | Temporal stability | A | A | A | B | B | A |
| | Curing properties | A | A | A | A | A | A |
| | Light resistance | A | A | A | A | B | A |

TABLE 8

| | | Comparative | Comparative | Comparative |
|---|---|---|---|---|
| | | Example 1 | Example 2 | Example 3 |
| Pigment | Compound B-1 | 1 | 1 | — |
| | Compound P-1 | — | — | 1 |
| Synergist | EFKA 6745 | — | — | 0.005 |
| | Compound S-3 | — | 0.005 | — |
| Polymerizable | SR341 | 54.100 | 54.095 | 54.095 |
| compound | (SP value 17.6 MPa^{1/2}) | | | |
| | NVC | 30 | 30 | 30 |
| | (SP value 20.0 MPa^{1/2}) | | | |
| Dispersant | EFKA PX 4701 | 1 | 1 | 1 |
| | (base number 40 mgKOH/g) | | | |
| Polymerization | Omnirad 819 | 4 | 4 | 4 |
| initiator | Omnirad TPO H | 4 | 4 | 4 |
| | Speedcure 7010L | 4 | 4 | 4 |
| Surfactant | BYK307 | 0.1 | 0.1 | 0.1 |
| Polymerization | UV12 | 1 | 1 | 1 |
| inhibitor | TEMPOL | 0.3 | 0.3 | 0.3 |
| | MEHQ | 0.5 | 0.5 | 0.5 |
| Dispersant/pigment | | 1 | 1 | 1 |
| Synergist/pigment × 100 | | — | 0.5 | 0.5 |
| Evaluation | Dispersibility | C | C | C |
| | Temporal stability | C | C | C |
| | Curing properties | A | A | A |
| | Light resistance | A | A | C |

As shown in Tables 1 to 7, it has been revealed that the inks of Examples 1 to 63 are excellent in dispersibility and temporal stability because the inks contain a squarylium dye represented by Formula 1, polymerizable compounds, a dispersant, and a synergist having at least one group selected from the group consisting of a carboxy group and a sulfo group and at least one ring selected from the group consisting of an aromatic ring and a heteroaromatic ring.

On the other hand, as shown in Table 8, it has been revealed that the ink of Comparative Example 1 is poor in dispersibility and temporal stability because the ink does not contain a synergist.

In Comparative Example 2, it has been revealed that the ink of Comparative Example 2 is poor in dispersibility and temporal stability because the synergist contained in the ink is not a synergist having at least one group selected from the group consisting of a carboxy group and a sulfo group.

It has been revealed that the ink of Comparative Example 3 is poor in dispersibility and temporal stability because the ink contains not a squarylium dye but a pyrrolopyrrole boron dye.

It has been revealed that dispersibility in Examples 4 and 33 is better than dispersibility in Example 1 because Examples 4 and 33 contain a dispersant having a base number of 15 mgKOH/g or more. Likewise, it has been revealed that dispersibility in Example 40 is better than dispersibility in Example 39 because Example 40 contains a dispersant having a base number of 15 mgKOH/g or more.

It has been revealed that dispersibility and temporal stability in Example 13 are better than dispersibility and temporal stability in Examples 20 and 23, because the content of the dispersant is 0.7% by mass to 5% by mass with respect to the total mass of the ink in Example 13. Likewise, it has been revealed that dispersibility and temporal stability in Example 46 are better than dispersibility and temporal stability in Examples 54 and 57, because the content of the dispersant is 0.7% by mass to 5% by mass with respect to the total mass of the ink in Example 46.

It has been revealed that curing properties in Example 7 are better than curing properties in Examples 4 and 5, and temporal stability in Example 7 is better than temporal stability in Example 6, because the content of the polymerizable compound having an SP value of 18 MPa^{1/2} or more is 10% by mass to 40% by mass with respect to the total mass of the ink in Example 7.

It has been revealed that temporal stability in Example 10 is better than temporal stability in Examples 7 to 9, because the content of the polymerization inhibitor is 1% by mass or more with respect to the total mass of the ink in Example 10. Likewise, it has been revealed that temporal stability in Example 45 is better than temporal stability in Examples 44, because the content of the polymerization inhibitor is 1% by mass or more with respect to the total mass of the ink in Example 45.

It has been revealed that curing properties in Example 13 are better than curing properties in Examples 10 to 12, because the content of the polymerization initiator is 10% by mass or more with respect to the total mass of the ink in Example 13. Likewise, it has been revealed that curing properties in Example 43 are better than curing properties in Examples 40 to 42, because the content of the polymerization initiator is 10% by mass or more with respect to the total mass of the ink in Example 43.

It has been revealed that temporal stability in Examples 13, 15, and 16 are better than temporal stability in Example 14, and dispersibility in Examples 13, 15, and 16 are better than dispersibility in Example 17, because the content of the synergist is 0.005% by mass to 0.1% by mass with respect to the total mass of the ink in Examples 13, 15, and 16. Likewise, it has been revealed that temporal stability in Examples 46, 48, and 49 is better than temporal stability in Example 47, and dispersibility in Examples 46, 48, and 49 is better than dispersibility in Example 50, because the content of the synergist is 0.005% by mass to 0.1% by mass with respect to the total mass of the ink in Examples 46, 48, and 49.

It has been revealed that temporal stability in Examples 13, 15, and 16 is better than temporal stability in Example 14, and dispersibility in Examples 13, 15, and 16 is better than dispersibility in Example 17, because the content of the synergist is 0.12% by mass to 15% by mass with respect to the total mass of the squarylium dye in Examples 13, 15, and 16. Likewise, it has been revealed that temporal stability in Examples 46, 48, and 49 is better than temporal stability in Example 47, and dispersibility in Examples 46, 48, and 49 is better than dispersibility in Example 50, because the content of the synergist is 0.12% by mass to 15% by mass with respect to the total mass of the squarylium dye in Examples 46, 48, and 49.

It has been revealed that dispersibility in Examples 35 and 37 is better than dispersibility in Examples 34 and 36, because the content of the synergist is 0.12% by mass to 15% by mass with respect to the total mass of the squarylium dye in Examples 35 and 37.

The entire disclosure of Japanese Patent Application No. 2020-061102, filed Mar. 30, 2020, is incorporated into the present specification by reference. In addition, all documents, patent applications, and technical standards described in the present specification are incorporated into the present specification by reference, as if each of the documents, the patent applications, and the technical standards is specifically and individually described.

What is claimed is:

1. An ink jet recording ink comprising:
a squarylium dye represented by Formula 1;
polymerizable compounds;
a dispersant; and
a synergist having at least one group selected from the group consisting of a carboxy group and a sulfo group and at least one ring selected from the group consisting of an aromatic ring and a heteroaromatic ring, 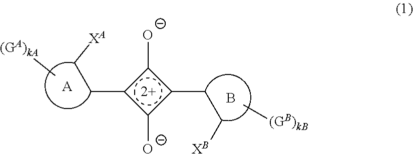
wherein in Formula 1, a ring A and a ring B each independently represent an aromatic ring or a heteroaromatic ring, X^{A} and X^{B} each independently represent a monovalent substituent, G^{A} and G^{B} each independently represent a monovalent substituent, kA represents an integer of 0 to nA, kB represents an integer of 0 to nB, nA represents the maximum number of G^{A}s capable of being bonded to the ring A, nB represents the maximum number of G^{B}s capable of being bonded to the ring B, X^{A} and G^{A} or X^{B} and G^{B} may be bonded to each other to form a ring, and in a case where there is a plurality of G^{A}s and a plurality of G^{B}s, the plurality of G^{A}s bonded to the ring A may be bonded to each other to form a ring structure and the plurality of G^{B}s bonded to the ring B may be bonded to each other to form a ring structure.

2. The ink jet recording ink according to claim 1,
wherein the dispersant has a base number of 15 mgKOH/g or more.

3. The ink jet recording ink according to claim 1,
wherein a ratio of a content of the dispersant to a content of the squarylium dye is 0.5 to 5 based on mass.

4. The ink jet recording ink according to claim 1,
wherein at least one of the polymerizable compounds is a polymerizable compound having a solubility parameter of 18 MPa^{1/2} or more, and
a content of the polymerizable compound having a solubility parameter of 18 MPa^{1/2} or more is 10% by mass to 40% by mass with respect to a total mass of the ink jet recording ink.

5. The ink jet recording ink according to claim 1, further comprising a polymerization inhibitor,
wherein a content of the polymerization inhibitor is 1% by mass or more with respect to a total mass of the ink jet recording ink.

6. The ink jet recording ink according to claim 5,
wherein the polymerization inhibitor is at least one compound selected from the group consisting of a nitrosamine compound, a hindered amine compound, a hydroquinone compound, and a nitroxyl radical.

7. The ink jet recording ink according to claim 1, further comprising a polymerization initiator,
wherein a content of the polymerization initiator is 10% by mass or more with respect to a total mass of the ink jet recording ink.

8. The ink jet recording ink according to claim 7,
wherein the polymerization initiator is at least one compound selected from the group consisting of an acylphosphine oxide compound and a thioxanthone compound.

9. The ink jet recording ink according to claim 1,
wherein a content of the synergist is 0.005% by mass to 0.1% by mass with respect to a total mass of the ink jet recording ink.

10. The ink jet recording ink according to claim 1,
wherein a content of the synergist is 0.12% by mass to 15% by mass with respect to a total mass of the squarylium dye.

11. An image recording method comprising:
applying the ink jet recording ink according to claim 1 to a substrate by an ink jet recording method to record an ink image; and
irradiating the ink image with active energy rays.
